(19) United States
(12) Patent Application Publication
(10) Pub. No.: US 2016/0355662 A1
(43) Pub. Date: Dec. 8, 2016

(54) METHOD FOR MANUFACTURING POROUS CELLULOSE PARTICLES AND POROUS CELLULOSE PARTICLES

(71) Applicant: FUJIFILM CORPORATION, Tokyo (JP)

(72) Inventors: Shinsuke TOKUOKA, Kanagawa (JP); Ritsuko HORI, Kanagawa (JP)

(21) Appl. No.: 15/238,723

(22) Filed: Aug. 17, 2016

Related U.S. Application Data
(63) Continuation of application No. PCT/JP2015/055993, filed on Feb. 27, 2015.

(30) Foreign Application Priority Data
Mar. 12, 2014 (JP) 2014-049274

(51) Int. Cl. C08J 9/28; C08B 16/00; C08B 1/00

(52) U.S. Cl. CPC C08J 9/28; C08B 1/003; C08B 16/00; C08J 2201/0546; C08J 2301/02

(57) ABSTRACT

Provided are a method of manufacturing porous cellulose particles, including a cellulose solution preparation step of preparing a cellulose solution by dissolving cellulose in an aqueous lithium bromide solution, a dispersion preparation step of preparing a cellulose solution dispersion by dispersing the cellulose solution in an organic dispersion medium, and a coagulation step of coagulating cellulose in the cellulose solution dispersion by cooling the cellulose solution dispersion and adding a coagulation solvent thereto such that porous particles are obtained, and porous cellulose particles obtained by the method for manufacturing porous cellulose particles.

### CROSS-REFERENCE TO RELATED APPLICATIONS

This application is a continuation application of International Application No. PCT/JP2015/055993, filed Feb. 27, 2015, the disclosure of which is incorporated herein by reference in its entirety. Further, this application claims priority from Japanese Patent Application No. 2014-049274, filed Mar. 12, 2014, the disclosure of which is incorporated herein by reference in its entirety.

### BACKGROUND OF THE INVENTION

1. Field of the Invention

The present invention relates to a method for manufacturing porous cellulose particles and porous cellulose particles.

2. Description of the Related Art

Porous cellulose particles are characterized by having particularly great mechanical strength amongst porous polysaccharide particles, hardly adsorbing proteins or the like in a non-specific manner, and being able to support various ligands by modifying a hydroxyl group. Therefore, porous cellulose particles are used as a carrier for various purposes.

In a case where porous cellulose particles are used as a carrier, it is important to appropriately control the pore size of the porous particles in order to determine a performance.

For example, the function of a porous filler used in liquid chromatography greatly depends on the pore size of the filler. In gel chromatography, each of components is separated out using differences in elution time resulting from the molecular size of each component contained in a mixture, and accordingly, the pore size of the carrier greatly affects the separation ability. In a case of a carrier for adsorption used in ion exchange chromatography, affinity chromatography, and the like, the amount of a target adsorbate that can be carried per a certain volume varies with the surface area of pores of the porous carrier. Therefore, in order to use porous particles as a carrier, the pore size of the porous particles needs to be controlled to be within a desired range.

In a case where porous cellulose particles are used for separation or used as a filtering material, if the flow rate of a fluid is increased, the porous particles are compressed due to the pressure of the fluid and deformed in some cases. In a case where the porous particles are deformed, the pore shape and pore size change, and this leads to problems in that it is difficult to control the pore size of the porous particles to be within an intended range and to use the porous particles at a high flow rate because compaction of the particles is caused in a column. These problems imply that mechanical strength of the porous cellulose particles is one necessary performance.

As a method for manufacturing porous cellulose particles, a method of causing granulation by dissolving cellulose directly in an aqueous calcium thiocyanate solution has been disclosed. The disclosure states that the obtained porous cellulose particles are used as a carrier for chromatography (for example, see JP3601229B and Journal of Chromatography A, 1980, 195, p 221-230).

As another method for preparing porous cellulose particles, a method has been disclosed in which a cellulose acetate butyrate ester or a cellulose diacetate ester is dissolved in a dichloromethane-containing solvent, the solution is suspended in an aqueous medium so as to form liquid droplets, the solvent is removed from the liquid droplets, and unmodified cellulose particles are formed by saponification (for example, see JP2525308B and the Journal of The Chemical Society of Japan, 1999, No. 11, p 733-737).

Furthermore, there has also been a disclosure regarding a technique for preparing a porous material, although it does not have a particle form, by dissolving cellulose in an aqueous lithium bromide solution, cooling the obtained cellulose solution in a container such that the solution is gelated, and then dipping the resultant in water (for example, see Cellulose, 2014, Vol. 21, p. 1175).

### SUMMARY OF THE INVENTION

However, in the method for manufacturing porous cellulose particles described in JP3601229B and Journal of Chromatography A, 1980, 195, p 221-230, the used aqueous calcium thiocyanate solution is toxic and corrosive, and hence a post-treatment needs to be performed through a series of steps. Furthermore, because the porous cellulose particles obtained by the manufacturing method described in the above documents have a large pore size and a small specific surface area, it is unlikely that the particles will be able to demonstrate excellent adsorption performance in a case where they are used as a carrier for chromatography or the like.

In the method for manufacturing porous cellulose particles described in JP2525308B and the Journal of The Chemical Society of Japan, 1999, No. 11, p 733-737, a modified cellulose compound is used as a raw material. Therefore, in order to convert the modified cellulose into unmodified cellulose, a process such as saponification is necessary, and accordingly, the number of steps for manufacturing is further increased compared with that in the method not using modified cellulose. In addition, in the manufacturing method described in the above documents, in order to control the pore size, a diluent such as an alcohol needs to be used. Accordingly, it takes a lot of trouble to wash and recover the diluent used for controlling the pore size, and the generated cellulose particles have a large pore size and a small specific surface area, which leads to a problem in that it is unlikely that the particles will be able to demonstrate excellent adsorption performance in a case where they are used as a carrier for chromatography or the like.

In Cellulose, 2014, Vol. 21, p. 1175, through a test, the formation of a porous material is attempted by coagulating an aqueous lithium bromide solution, in which cellulose is dissolved, in a container. However, the obtained porous cellulose material has low mechanical strength, and it cannot be said that the material has strength sufficient for practical use. Furthermore, in Cellulose, 2014, Vol. 21, p. 1175, the improvement of the strength of the porous cellulose material and the formation of porous cellulose particles are not investigated.

Therefore, currently, there is no simple method for manufacturing porous cellulose particles having pores controlled to have a uniform pore size.

Objects of the present invention are to provide a method for manufacturing porous cellulose particles having a large specific surface area, controlled pores, and excellent mechanical strength and to provide porous cellulose particles having a large specific surface area, controlled pores, and excellent mechanical strength.

As a result of conducting intensive investigation, the inventors of the present invention obtained the knowledge that the above objects can be achieved through a step of dissolving cellulose in a specific solvent without esterifying the cellulose and then preparing a cellulose solution dispersion. Based on this knowledge, they accomplished the present invention.

The present invention includes the following embodiments.

<1> A method for manufacturing porous cellulose particles, comprising a cellulose solution preparation step of preparing a cellulose solution by dissolving cellulose in an aqueous lithium bromide solution, a dispersion preparation step of preparing a cellulose solution dispersion by dispersing the cellulose solution in an organic dispersion medium, and a coagulation step of coagulating cellulose in the cellulose solution dispersion by cooling the cellulose solution dispersion and adding a coagulation solvent thereto such that porous particles are obtained.

<2> The method for manufacturing porous cellulose particles described in <1>, further comprising a washing step of washing the porous particles obtained through the coagulation step.

<3> The method for manufacturing porous cellulose particles described in <1> or <2>, further comprising a cross-linking step of forming a cross-linked structure in the porous particles obtained through the coagulation step.

<4> The method for manufacturing porous cellulose particles described in <3>, in which the washing step is performed at at least any one of a point in time before the cross-linking step or a point in time after the cross-linking step.

<5> The method for manufacturing porous cellulose particles described in <4>, in which the washing step is performed before the cross-linking step.

<6> The method for manufacturing porous cellulose particles described in <5>, in which the washing step is a step of making each of the content of lithium ions and the content of bromide ions in a dry mass of 1 kg of the porous particles become equal to or less than 800 mmol.

<7> The method for manufacturing porous cellulose particles described in any one of <3> to <6>, in which the cross-linking step is a step of forming a cross-linked structure in the porous particles obtained through the coagulation step by using epichlorohydrin.

<8> The method for manufacturing porous cellulose particles described in any one of <1> to <7>, in which the content of lithium bromide in the aqueous lithium bromide solution is equal to or greater than 50% by mass and equal to or less than 70% by mass.

<9> The method for manufacturing porous cellulose particles described in any one of <1> to <8>, in which the content of cellulose in the cellulose solution is equal to or greater than 1% by mass and equal to or less than 15% by mass.

<10> The method for manufacturing porous cellulose particles described in any one of <1> to <9>, in which a cooling rate at the time of cooling the cellulose solution dispersion is equal to or greater than 0.2° C./min and equal to or less than 50° C./min.

<11> The method for manufacturing porous cellulose particles described in any one of <1> to <10>, further comprising a freeze-drying sep of freeze-drying the porous cellulose particles so as to obtain freeze-dried porous cellulose particles.

<12> Porous cellulose particles obtained by the method for manufacturing porous cellulose particles described in any one of <1> to <11>.

<13> The porous cellulose particles described in <12>, in which a modulus of elasticity of the porous cellulose particles calculated from a load at the time when the porous cellulose particles has a 5% strain measured by a microhardness tester is equal to or greater than 8 MPa.

<14> The porous cellulose particles described in <12> or <13>, in which an average pore size measured through mercury intrusion porosimetry by freeze-drying the porous cellulose particles is equal to or greater than 10 nm and equal to or less than 2,000 nm.

<15> The porous cellulose particles described in any one of <12> to <14>, in which a specific surface area measured through mercury intrusion porosimetry by freeze-drying the porous cellulose particles is equal to or greater than 140 m²/g.

<16> The porous cellulose particles described in any one of <12> to <15> that has a volume average particle size of equal to or greater than 1 μm and equal to or less than 2,000 μm.

<17> The porous cellulose particles described in any one of <12> to <16>, in which the content of lithium ions in 1 kg of dry particles obtained by drying the porous cellulose particles is equal to or greater than 0.0001 mmol and equal to or less than 100 mmol.

<18> The porous cellulose particles described in any one of <12> to <17>, in which the content of bromide ions in 1 kg of dry particles obtained by drying the porous cellulose particles is equal to or greater than 0.0001 mmol and equal to or less than 100 mmol.

In the present specification, a range of numerical values described using “to” means a range including the numerical values listed before and after “to” as a lower limit and an upper limit respectively.

In the present specification, the term “step” includes not only an independent step, but also a step that is not clearly differentiated from other steps as long as the intended purpose thereof can be achieved.

In the present specification, in a case where the amount of each of the components in a composition is mentioned, if there is a plurality of substances corresponding to each of the components in the composition, unless otherwise specified, the amount means the total amount of the plurality of substances present in the composition.

According to the present invention, it is possible to provide a method for manufacturing porous cellulose particles having a large specific surface area, controlled pores, and excellent mechanical strength and to provide porous cellulose particles having a large specific surface area, controlled pores, and excellent mechanical strength.

### BRIEF DESCRIPTION OF THE DRAWINGS

FIG. 1 is a scanning electron micrograph in which porous cellulose particles obtained in Example 10 are imaged under 200× magnification.

FIG. 2 is a scanning electron micrograph in which the porous cellulose particles obtained in Example 10 are imaged under 30,000× magnification.

### DESCRIPTION OF THE PREFERRED EMBODIMENTS

Hereinafter, specific embodiments of the present invention will be described in detail, but the present invention is not limited to the following embodiments. The present invention can be embodied by appropriately adding modification within the intended scope of the present invention.

A method for manufacturing porous cellulose particles of the present invention includes (I) a cellulose solution preparation step of preparing a cellulose solution by dissolving cellulose in an aqueous lithium bromide solution (hereinafter, referred to as a cellulose solution preparation step in some cases), (II) a dispersion preparation step of preparing cellulose solution dispersion by dispersing the cellulose solution in an organic dispersion medium (hereinafter, referred to as a dispersion preparation step), and (III) a coagulation step of coagulating cellulose in the cellulose solution dispersion by cooling the cellulose solution dispersion and adding a coagulation solvent so as to obtain porous particles (hereinafter, referred to as a cellulose coagulation step or a coagulation step).

Hereinafter, the manufacturing method of the present invention will be specifically described in order of the steps.

(I) Cellulose Solution Preparation Step of Preparing Cellulose Solution by Dissolving Cellulose in an Aqueous Lithium Bromide Solution (Cellulose Solution Preparation Step)

[Cellulose]

In the present invention, any cellulose can be used without particular limitation as long as it dissolves in an aqueous lithium bromide solution which will be described later.

Examples of the cellulose usable in the present invention include crystalline cellulose powder, recycled cellulose, substituted cellulose such as cellulose acetate, and the like.

One kind of cellulose may be used singly, or two or more kinds thereof may be used in combination.

Among these, in order for the manufactured porous cellulose particles to obtain mechanical strength of a level preferred for practical use, crystalline cellulose or recycled cellulose is preferable as the cellulose used for preparing a cellulose solution, and crystalline cellulose is more preferable.

The average degree of polymerization of the cellulose is preferably equal to or greater than 30 and equal to or less than 2,000. It is preferable that the average degree of polymerization of the cellulose is equal to or less than 2,000, because then the increase in viscosity of the solution at the time of dissolving the cellulose can be inhibited. Furthermore, it is preferable that the average degree of polymerization of the cellulose is equal to or greater than 30, because then the mechanical strength of the obtained porous cellulose particles reaches a level sufficient for practical use.

The degree of polymerization is more preferably within a range of equal to or greater than 40 and equal to or less than 1,500, even more preferably within a range of equal to or greater than 50 and equal to or less than 1,000, and particularly preferably within a range of equal to or greater than 100 and equal to or less than 850.

The average degree of polymerization of the cellulose can be measured by the method described in paragraph “0032” in JP1994-298999A (JP-H06-298999A). More specifically, it can be measured based on the method described in B. DALBE, A. PEGUY, et al, “CELLULOSE CHEMISTRY AND TECHNOLOGY”, Vol. 24, No. 3, p 327-331 (1990). That is, in the measurement method described in the above document, a solvent, which is obtained by mixing a hydrate of N-methylmorpholine-N-oxide, dimethylsulfoxide, and propyl gallate together at a weight ratio of 100/150/1, is used as a solvent for dissolving cellulose; cellulose is dissolved at a concentration of 0.2 g/100 mL to 0.8 g/100 mL; the intrinsic viscosity of the obtained cellulose solution is measured using a Ubbelohde-type dilution viscometer at a temperature of 34° C.; and the degree of polymerization of the cellulose is determined by the following viscosity equation (1).

[η]=1.99×(DP)v^{0.79} Viscosity equation (1)

In the viscosity equation (1), [η] represents intrinsic viscosity, and (DP)v represents a degree of polymerization of cellulose.

As the cellulose, a commercially available product may be used. In a case where a commercially available product is used, the average degree of polymerization described in the catalog can be referred to.

Examples of the commercially available product of the cellulose usable in the present invention include CEOLUS (registered trademark) PH101 (trade name, average degree of polymerization: 220) and various other products of the CEOLUS PH grade, KG grade, and UF grade manufactured by Asahi Kasei Chemicals Corporation.; KC-FLOCK W-400G (trade name, average degree of polymerization: 350), KC-FLOCK W-300G (trade name, average degree of polymerization: 370), KC-FLOCK W-200G (trade name, average degree of polymerization: 510), KC-FLOCK W-100G (trade name, average degree of polymerization: 720), KC-FLOCK W-50G (trade name, average degree of polymerization: 820), and sulfite pulp NDPT (trade name, average degree of polymerization: 1,000) manufactured by NIPPON PAPER INDUSTRIES CO., LTD.; and the like.

[Aqueous Lithium Bromide Solution]

The aqueous lithium bromide solution is prepared by dissolving lithium bromide in water. As water used as the solvent, it is preferable to use deionized water, pure water, or the like because these contain a small amount of impurities.

The content of lithium bromide in the aqueous lithium bromide solution is preferably 50% by mass to 70% by mass, more preferably 54% by mass to 69% by mass, and even more preferably 56% by mass to 68% by mass.

If the content of the lithium bromide is equal to or more than 50% by mass, the solubility of cellulose becomes excellent. If it is equal to or less than 70% by mass, lithium bromide crystals sufficiently dissolve, and remaining of insoluble substances, precipitation of lithium bromide crystals, and the like are inhibited.

The aqueous lithium bromide solution is prepared by dissolving lithium bromide in water with stirring if necessary. The aqueous lithium bromide solution may be prepared at room temperature (25° C.) or at a temperature of about 0° C. to 80° C. as desired.

[Preparation of Cellulose Solution]

By dissolving cellulose in the obtained aqueous lithium bromide solution, a solution in which cellulose is dissolved in the aqueous lithium bromide solution is prepared (hereinafter, referred to as a cellulose solution in some cases).

At the time of dissolving cellulose in the aqueous lithium bromide solution, cellulose should be dissolved in a state where the aqueous lithium bromide solution is heated to 80° C. to 150° C. and stirred if necessary. The temperature at which the cellulose is dissolved is preferably within a range of 85° C. to 140° C., and more preferably within a range of 90° C. to 130° C.

Because the aqueous lithium bromide solution used for preparing the cellulose solution excellently dissolves cellulose, the dissolution rate of cellulose becomes higher than in a case where the cellulose solution is prepared by a calcium thiocyanate method, and the heating time taken for dissolution is shortened. Accordingly, it is possible to suppress the coloring of cellulose resulting from heating in the cellulose solution preparation step, and this is one of the advantages of the present invention.

In addition, the viscosity of the cellulose solution obtained by dissolving cellulose by using the aqueous lithium bromide solution is lower than the viscosity of the cellulose solution obtained by a calcium thiocyanate method. Accordingly, the manufacturing method of the present invention also has such an advantage that the particle size of cellulose particles formed in the dispersion preparation step, which will be described later, and voids in the porous particles can be easily controlled.

In the cellulose solution preparation step, the content of cellulose with respect to the total amount of the prepared cellulose solution is preferably within a range of 1% by mass to 15% by mass, more preferably 1.5% by mass to 12% by mass, and even more preferably 2% by mass to 10% by mass.

If the content of cellulose in the cellulose solution is equal to or greater than 1% by mass, the viscosity of the cellulose solution is appropriately maintained, fluidity becomes excellent, and particles having different shapes do not easily occur at the time of preparing a dispersion in the next step. Furthermore, if the content of cellulose in the cellulose solution is equal to or less than 15% by mass, the viscosity of the cellulose solution is appropriately maintained, and handleability becomes excellent.

(II) Dispersion Preparation Step of Preparing Cellulose Solution Dispersion by Dispersing Cellulose Solution in Organic Dispersion Medium (Dispersion Preparation Step)

In the dispersion preparation step, by adding the cellulose solution obtained in the (I) cellulose solution preparation step to an organic dispersion medium and performing a dispersion method, a cellulose solution dispersion in which spherical cellulose solution is dispersed in the organic dispersion medium is prepared. In the present specification, a component which includes the organic dispersion medium and forms a continuous phase in a dispersion containing the cellulose solution as a disperse phase is referred to as a “dispersion medium”. The dispersion medium contains the organic dispersion medium which will be described later and may contain a surfactant, a dispersant, and the like as desired.

Examples of the method for obtaining the spherical cellulose solution dispersion by a dispersion method include a method of adding the cellulose solution to the dispersion medium and performing an emulsification treatment, a dispersion treatment, or the like by an operation such as stirring. As will be described below, the emulsification treatment, the dispersion treatment, or the like can be performed by a common method.

[Dispersion Medium]

In the dispersion preparation step, the dispersion medium used for preparing a dispersion contains an organic dispersion medium poorly compatible with the cellulose solution, specifically, an organic dispersion medium selected from organic dispersion media poorly compatible with the solvent contained in the cellulose solution.

From the viewpoint of making a more uniform disperse phase of the cellulose solution, it is preferable that the dispersion medium added to the cellulose solution further contains a surfactant in addition to the organic dispersion medium.

The organic dispersion medium poorly compatible with the cellulose solution is preferably one or more kinds of organic dispersion medium selected from organic solvents and oleaginous components which are in a liquid state at room temperature (25° C.) and cause visually confirmable phase separation after being stirred and mixed together with the cellulose solution obtained in the preceding step at an arbitrary ratio and then left to stand for 5 minutes at room temperature (25° C.).

By using the organic dispersion medium poorly compatible with the cellulose solution, a disperse phase in which the cellulose solution is dispersed in the form of spheres in the dispersion medium is formed at the time of performing the dispersion treatment.

Examples of the organic dispersion medium include lipophilic organic solvents such as dichlorobenzene, dichloroethane, toluene, benzene, and xylene; cooking oil such as medium chain fatty acid triglyceride (MCT); natural oil such as olive oil, castor oil, rapeseed oil, mustard oil, palm oil, coconut oil, and squalane; alcohols having an alkyl group having 4 to 36 carbon atoms, such as isostearyl alcohol, oleyl alcohol, and 2-octyldecanol; an ester having 4 to 60 carbon atoms such as glyceryl trioctanoate; others such as liquid paraffin, silicone oil, animal oil, and mineral oil; and the like. Among these, one or more kinds of organic dispersion medium selected from the group consisting of dichlorobenzene, toluene, xylene, olive oil, castor oil, rapeseed oil, silicone oil, glyceryl trioctanoate, and liquid paraffin is preferable, and liquid paraffin, olive oil, and the like are preferable because these have appropriate viscosity and can further stabilize the dispersion state.

[Surfactant]

In a case where a surfactant is used in the dispersion preparation step, as the surfactant, a surfactant should be selected which has a hydrophilic group or a hydrophobic group at such a ratio that can contribute to the stabilization of a disperse phase when a dispersion containing the cellulose solution as a dispersion medium is prepared using a dispersion medium containing one or more kinds of organic dispersion medium selected from the aforementioned organic solvents and oleaginous components.

Examples of the surfactant usable in the present invention include a sorbitan fatty acid ester and a glycerin fatty acid ester.

Specific examples of the sorbitan fatty acid ester include sorbitan fatty acid esters such as sorbitan laurate, sorbitan stearate, sorbitan oleate, sorbitan palmitate, and sorbitan trioleate; polyoxyethylene sorbitan fatty acid esters such as polyoxyethylene (20) sorbitan monolaurate, polyoxyethylene (4) sorbitan monostearate, polyoxyethylene (5) sorbitan monooleate, polyoxyethylene (4) sorbitan tristearate, polyoxyethylene (4) sorbitan trioleate, and polyoxyethylene (20) sorbitan monostearate; and the like. In the name of the above surfactant, the numerical values in the bracket represents the number of oxyethylene groups linked to each other in a polyoxyethylene chain.

Examples of the glycerin fatty acid ester include monoglycerin acid esters such as a glycerin monolauric acid ester, a glycerin monooleic acid ester, a glycerin monostearic acid ester, and a glycerin monopalmitic acid ester; and polyglycerin fatty acid esters such as a glycerin acetic acid ester polyglycerin fatty acid ester and a polyglycerin condensed ricinoleic acid ester. The polyglycerin fatty acid ester can be made into a hydrophilic surfactant or a hydrophobic surfactant by controlling the type of fatty acid, the number of glycerin monomers polymerized, and the like.

Among the surfactants usable in the dispersion preparation step, from the viewpoint of making it easier to control the particle size of the dispersion particles, sorbitan laurate, sorbitan palmitate, sorbitan stearate, sorbitan oleate, a glycerin monostearic acid ester, a glycerin monopalmitic acid ester, and the like are more preferable.

In the dispersion preparation step, it is preferable to use a surfactant by adding it to the organic dispersion medium in an appropriate amount in advance.

The content of the surfactant is preferably within a range of 0.01% by mass to 10% by mass, more preferably within a range of 0.05% by mass to 5% by mass, and even more preferably within a range of 0.1% by mass to 3% by mass, with respect to the total amount of the dispersion medium. If the content of the surfactant is within the above range, it is easy to form the cellulose solution droplets having uniform particle size, the effect resulting from the addition of the surfactant is sufficiently obtained, and the occurrence of aggregation of the dispersion medium is inhibited.

At the time of preparing the dispersion, in addition to the surfactant, a known dispersant other than the surfactant, such as ethyl cellulose, can be used by being dissolved in the dispersion medium. If the dispersion medium contains a dispersant such as ethyl cellulose, the viscosity of the dispersion medium can be changed according to the purpose. Accordingly, by adjusting the viscosity of the dispersion medium, the particle size of the dispersion particles of the cellulose solution can be more easily controlled to be a desired value.

[Liquid Ratio]

In the dispersion preparation step, a volume ratio between the disperse phase formed of the cellulose solution and the dispersion medium is not particularly limited as long as the ratio is within a range in which the dispersion containing the cellulose solution as the disperse phase can be formed at the time of performing the operation of a dispersion treatment such as an emulsification treatment. The volume ratio (disperse phase/dispersion medium) between the disperse phase (cellulose solution) and the dispersion medium is preferably equal to or less than 1.0 because then the occurrence of particles having different shapes is inhibited. The volume ratio between the disperse phase and the dispersion medium is more preferably equal to or less than 0.7, and even more preferably equal to or less than 0.5.

[Preparation of Dispersion]

As the method for preparing the dispersion, a known method can be appropriately selected and applied. Examples of the method used for preparing the dispersion include a method of mixing the cellulose solution with the dispersion medium and dispersing the obtained mixture by applying shearing force. Examples of the method for applying shearing force include a method of using a mixer such as a propeller-type stirrer or a turbine-type stirrer, a method of using a colloid mill, a method of using a homogenizer, a method of using ultrasonic waves, and the like.

The particle size of the spherical cellulose disperse phase in the dispersion can be controlled by controlling the dispersion preparation conditions, for example, various conditions such as the dispersion apparatus used, the shearing force application conditions, the temperature at the time of preparing the dispersion, and the dispersion time, by a common method.

For example, generally, the particle size of the disperse phase tends to be reduced by increasing the shearing force applied, increasing the temperature at the time of preparing the dispersion, lengthening the dispersion time, and the like.

[Temperature]

The temperature condition in the dispersion preparation step is not particularly limited as long as cellulose is not thermally decomposed at the temperature. From the viewpoint of efficiently preparing a uniform dispersion, the temperature of the cellulose solution dispersion is preferably within a range of 80° C. to 150° C., more preferably 85° C. to 140° C., and even more preferably 90° C. to 130° C.

It is preferable that the dispersion is prepared by heating the dispersion medium containing a surfactant, a dispersant, and the like if necessary such that the dispersion medium becomes in the above temperature range, and then adding the cellulose solution thereto.

In the dispersion preparation step, it is preferable to keep the temperature of the dispersion medium within the above range until the step ends.

[Dispersion Time]

The dispersion time is appropriately adjusted according to the dispersion apparatus used and the intended particle size of the disperse phase. For example, in a case where a mixer is used for preparing the dispersion, the dispersion time is preferably within a range of 1 minute to 60 minutes under a stirring condition at a rotation frequency of 100 rpm to 2,000 rpm.

The particle size of the disperse phase formed of the cellulose solution prepared in the dispersion preparation step is appropriately selected according to the use of the porous cellulose particles. The particle size of the disperse phase formed in the dispersion preparation step determines the particle size of the porous cellulose particles obtained. Although the preferred particle size of the porous cellulose particles will be described later, in the dispersion preparation step, it is preferable to select the dispersion conditions such that a disperse phase having a particle size appropriate as the intended particle size of the porous cellulose particles can be obtained.

The particle size of the disperse phase can be controlled by the aforementioned physical conditions for preparing the dispersion and by, for example, the type and amount of the surfactant used at the time of preparing the dispersion, the type and amount of the dispersant, and the like through a common method.

The particle size of the disperse phase can be measured using an optical microscope at normal temperature in a state where the disperse phase is gelated after the cooling step described below and the shape thereof is stabilized.

(III) Coagulation Step of Coagulating Cellulose in Cellulose Solution Dispersion by Cooling Cellulose Solution Dispersion and Adding Coagulation Solvent Thereto (Cellulose Coagulation Step)

The porous particles obtained by the cellulose coagulation step are particles having a porous structure that are formed in a manner in which the cellulose dissolved and contained in the disperse phase of the cellulose solution dispersion coagulates by coming into contact with a coagulation solvent. In the obtained particles, impurities remain. Hereinafter, the porous particles which are obtained by the cellulose coagulation step and contain residual impurities are referred to as “unpurified porous particles” as appropriate.

[Cooling]

In the cellulose coagulation step, the cellulose solution dispersion prepared at a temperature of 80° C. to 150° C. according to a preferred embodiment in the aforementioned dispersion preparation step is cooled such that the cellulose contained in the disperse phase is gelated.

As will be specifically described below, it is preferable to cool the dispersion until the temperature thereof falls into a range of 0° C. to 80° C.

If the cooling time taken until the intended temperature is obtained is long, particles having different shapes may occur due to the change of the shape of the disperse phase, or the gelated cellulose particles may be colored. If the cooling time is too short, particles having great mechanical strength are not obtained.

From the viewpoint described above, it is preferable to control the cooling rate according to the purpose. Specifically, the cooling rate is preferably 0.2° C./min to 50° C./min, more preferably 0.5° C./min to 20° C./min, and even more preferably 1.0° C./min to 10° C./min.

The degree of crystallization of the cellulose in the obtained cellulose particles can be controlled by regulating the cooling rate. For example, by increasing the cooling rate, the degree of crystallization can be reduced, and by reducing the cooling rate, the degree of crystallization can be increased.

By keeping the degree of crystallization low, particles with small anisotropy can be obtained, and by increasing the degree of crystallization, particles having excellent mechanical strength can be obtained.

The dispersion is prepared under the aforementioned preferred temperature condition at the aforementioned preferred volume ratio of disperse phase/dispersion medium. Then, the dispersion is cooled a preferred cooling rate that is adopted at the time of cooling the dispersion as described above, and at this time, the dispersion is continuously stirred at a certain stirring rate, for example, 100 rpm to 2,000 rpm. As a result, the disperse phase composed of the cellulose solution formed through dispersion is gelated and has uniform particle size, and particles close to perfect spheres are formed.

The stirring rate described above is an example, and the stirring condition is appropriately selected according to the type of the dispersion medium used, the raw material of cellulose, the concentration and viscosity of the cellulose solution, the shape and size of a stirring blade in the stirrer, the type of the reaction container, and the like. Furthermore, the cooling rate, the stirring condition, and the like are appropriately selected according to the intended particle size of the porous cellulose particles and the degree of crystallization.

[Coagulation]

The dispersion medium such as dichlorobenzene containing an organic solvent, which is poorly compatible or incompatible with the water-containing cellulose solution, is not uniformly mixed with the cellulose solution without causing phase separation or does not become compatible with the cellulose solution. Therefore, by adding a coagulation solvent to the aqueous lithium bromide solution-containing dispersion, which is formed in the dispersion preparation step and then gelated by cooling, the cellulose in the disperse phase is coagulated, and then the lithium bromide is separated and removed from the disperse phase.

As the coagulation solvent, a solvent which can dissolve a lithium bromide salt is used.

As the coagulation solvent, lower alcohols having 1 to 5 carbon atoms, such as ethanol, methanol, and isopropanol; ketones such as acetone and methyl ethyl ketone; ester such as ethyl acetate; ether such as tetrahydrofuran; water; and the like are preferable.

One kind of coagulation solvent may be used singly, or two or more kinds thereof may be used in combination.

After the temperature of the cooled dispersion becomes about 0° C. to 80° C., the dispersion is brought into contact with the coagulation solvent. In this way, the cellulose in the disperse phase is coagulated and regenerated.

The temperature of the cooled dispersion is preferably within a range of 0° C. to 80° C., more preferably within a range of 1° C. to 70° C., and even more preferably within a range of 2° C. to 60° C. If the temperature of the cooled dispersion is within the above range, spherical coagulated particles having an excellent shape are formed, and the time required for manufacturing falls in to an appropriate range.

In the cellulose coagulation step, in order to regenerate cellulose by removing lithium bromide from the disperse phase, in addition to the aforementioned method of adding the coagulation solvent to the dispersion, a method of pouring the dispersion as it is into the coagulation solvent and then gently stirring the resultant may be used for coagulating the cellulose. Furthermore, for example, it is possible to use a method of coagulating the cellulose by removing most of the dispersion medium by means such as decantation or filtration, pouring the separated and obtained disperse phase into the coagulation solvent, and gently stirring the resultant, a method of obtaining porous particles by separating and obtaining the disperse phase from which the dispersion medium has been removed by using the coagulation solvent and washing the disperse phase, and the like.

Hereinafter, the treatment for removing lithium bromide from the disperse phase is referred to as a desalting treatment in some cases.

The porous particles obtained by removing the coagulation solvent by decantation, filtration, or the like are particles which contain impurities such as a dispersion medium, an organic solvent like a coagulation solvent, a lithium bromide salt, a dispersant other than a surfactant that is used as desired, and a surfactant.

At the time the coagulation of cellulose, porous particles are formed by the coagulation of cellulose, without a great change of the particle shape of the disperse phase composed of the cellulose solution. Accordingly, in the manufacturing method of the present invention, by controlling the particle size of the disperse phase in the dispersion, the particle size of the obtained porous cellulose particles can be controlled.

The size of the obtained porous cellulose particles can be controlled by a common method according to, for example, various conditions at the time of preparing the dispersion, the stirring condition at the time of bringing the dispersion into contact with the coagulation solvent, the type of the surfactant used at the time of preparing the dispersion, the type of the dispersant other than the surfactant used at the time of preparing the dispersion, and the like.

The manufacturing method of the present invention does not need to use a corrosive compound such as calcium thiocyanate. Furthermore, the manufacturing method of the present invention has such an advantage that it makes it possible to efficiently manufacture porous cellulose particles having a large specific surface area and an intended particle size in a simple way by using a method not including a step of altering the cellulose itself such as a step of gelating the cellulose itself.

(IV) Additional Optional Step

The method for manufacturing porous cellulose particles of the present invention may have additional optional steps described below in addition to the aforementioned respective steps.

Examples of the optional steps include a washing step of washing the unpurified porous particles after the coagulation step so as to remove impurities, a cross-linking step of forming a cross-linked structure in the porous particles so as to obtain porous cellulose particles having improved particle strength, a freeze-drying step for thoroughly drying the wet porous cellulose particles obtained through at least any one of the washing step or the cross-linking step, and the like.

(IV-1) Washing Step

In the present invention, the manufacturing method preferably includes the washing step of washing the porous particles obtained through the coagulation step.

The washing step is a step of washing the unpurified porous particles obtained through the coagulation step with a wash solution containing water, an aqueous solvent, and the like such that impurities are removed and purified porous cellulose particles are obtained.

The unpurified porous particles obtained through the coagulation step contain various impurities such as bromide ions and lithium ions resulting from lithium bromide used for preparing the cellulose solution and the solvent used for forming the disperse phase.

Furthermore, the porous particles having undergone the cross-linking step, which will be described later, contain various impurities such as a cross-linking agent, a surfactant, and a solvent.

Therefore, it is preferable to remove the impurities by performing the washing step on the porous particles.

In a case where the cross-linking step, which will be described later, is performed, the washing step can be performed at at least any one of a point in time before the cross-linking step or a point in time after the cross-linking step.

From the viewpoint of improving the efficiency of the cross-linking reaction in the cross-linking step, it is preferable to perform the washing step before the cross-linking step. Furthermore, it is more preferable to perform the washing step before and after the cross-linking step.

The wash solution used in the washing step can contain at least one kind of component selected from the group consisting of water and an organic solvent such as methanol or ethanol. As the main component of the wash solution, water, ethanol, and a mixture of water and ethanol are preferable, and water is more preferable.

According to the purpose, the wash solution may further contain an additive such as a surfactant.

The water used in the wash solution is not particularly limited. However, distilled water, deionized water, pure water, and the like are preferable because these contain a small amount of impurities.

As the washing method in the washing step, any method can be used without limitation. Examples of the washing method include a method of washing the porous particles by bring them into contact with the wash solution and then separating the washed porous cellulose particles from the wash solution, a method of washing the porous particles by continuously supplying the wash solution to the porous particles placed in a container permeable to liquid, and the like.

In a case where the porous particles are washed by being brought into contact with the wash solution, an operation of stirring the wash solution may be performed. Furthermore, the porous particles may be washed two or more times by replacing the wash solution. In a case where the porous particles are washed by being brought into contact with the wash solution, the amount of the wash solution used is preferably set such that the porous particles sufficiently come into contact with the wash solution, because then the washing properties are further improved.

The porous cellulose particles from which impurities have been removed through the washing step can be used as they are for various purposes.

(IV-2) Cross-Linking Step

In order to further improve the strength of the porous cellulose particles obtained by the manufacturing method of the present invention, the manufacturing method of the present invention may further include a cross-linking step of forming a cross-linked structure in cellulose by using a cross-linking agent for the obtained porous cellulose particles.

Because the porous cellulose particles having a cross-linked structure have particularly excellent strength, they are also suitable for being used at a high linear velocity or under a high pressure.

The cross-linking agent used in the cross-linking step and the cross-linking reaction condition are not particularly limited, and the cross-linking step can be performed using a known technique in consideration of the conditions for imparting necessary strength to the porous cellulose particles to be obtained.

Examples of the cross-linking agent usable in the cross-linking step include halohydrin such as epichlorohydrin, epibromohydrin, and dichlorohydrin; and polyfunctional polyepoxide such as trimethylolpropane polyglycidyl ether like trimethylolpropane triglycidyl ether, glycerol polyglycidyl ether, pentaerythritol polyglycidyl ether, diglycerol polyglycidyl ether, polylgycerol polyglycidyl ether, and sorbitol polyglycidyl ether. Among theses, from the viewpoint of further improving the strength of the porous cellulose particles, it is preferable to use epichlorohydrin as the cross-linking agent.

The cross-linking step can be performed by a method in which the porous particles obtained through the coagulation step are brought into contact with an aqueous alkaline solution or an organic solvent containing the cross-linking agent and sufficiently reacted at a temperature in a range of 0° C. to 90° C. for 1 hour to 24 hours.

The content of the cross-linking agent is not particularly limited, but is preferably within a range of 0.1 parts by volume to 10 parts by volume with respect to 1 part by volume of the porous particles. Furthermore, in order to improve the reaction efficiency, it is desired to add a reductone such as sodium borohydride to the aqueous alkaline solution or the organic solvent containing the cross-linking agent.

By performing the cross-linking step on the porous particles, the cellulose constituting the porous particles form a cross-linked structure. As a result, the strength of the porous cellulose particles obtained through the cross-linking step becomes higher than the strength of the porous cellulose particles obtained by washing the porous particles.

Before performing the aforementioned cross-linking step, it is preferable to perform the aforementioned washing step of washing the porous particles obtained through the coagulation step with the wash solution.

The porous particles contain various impurities such as bromide ions and lithium ions resulting from lithium bromide and a solvent.

Through investigation, the inventors of the present invention found that if bromide ions, lithium ions, and the like remain in the porous particles at the time of the cross-linking step, the aggregation of the cellulose molecules or the formation of the cross-linked structure of the cellulose molecules by the cross-linking agent may be hindered. It is considered that, in contrast, if the amount of residual lithium ions, bromide ions, and the like is small, the cellulose molecules are firmly aggregated with each other, a strong cross-linked structure is formed, and hence the obtained porous cellulose particles can exhibit greater mechanical strength.

Accordingly, from the viewpoint of obtaining porous cellulose particles having greater mechanical strength, after the coagulation step, it is preferable to remove impurities in the porous particles by performing the aforementioned washing step before the cross-linking step and then to perform the cross-linking step.

The wash solution used in the washing step performed before the cross-linking step preferably contains water. The wash solution can contain one or more kinds of component selected from a hydrophilic solvent, a surfactant, and the like in addition to water. Particularly, the wash solution is preferably water selected from distilled water, deionized water, pure water, and the like.

In the washing step preceding the cross-linking step, from the viewpoint of further improving the efficiency of the formation of a cross-linked structure, it is preferable to wash the porous particles until each of the amount of lithium ions and the amount of bromide ions contained in the porous particles becomes equal to or less than 2,000 mmol per a dry mass of 1 kg of the porous particles. Each of the amount of lithium ions and the amount of bromide ions is more preferably equal to or less than 1,000 mmol, even more preferably equal to or less than 800 mmol, and particularly preferably equal to or less than 200 mmol, per a dry mass of 1 kg of the porous particles.

The dried porous particles used for measuring the content of lithium ions and bromide ions in porous particles having not yet been subjected to the cross-linking step can be obtained as below.

The wet porous particles obtained through the coagulation step are brought into contact with a solvent such as ethanol such that the solvent is substituted with ethanol or the like, and then the solvent ethanol is substituted again with t-butanol. Then, the porous particles are freezed at a temperature of equal to or less than −18° C. and freeze-dried by a common method, whereby dried porous particles can be obtained. By using the obtained dried porous particles as a sample, the content of lithium ions and bromide ions can be measured.

The residual lithium ions in the porous particles can be measured using an ICP emission spectrometer (OPTIMA 7300 DV, manufactured by PerkinElmer Inc.) under the standard conditions of the spectrometer. During the measurement, the dried porous particles are made into a solution by using an acid (70% by mass aqueous nitric acid solution), the amount of lithium ions contained in the solution is determined, and the content of lithium ions per dry mass of 1 kg of the porous particles is calculated.

The residual bromide ions in the porous particles can be measured using a combustion-type halogen analyzer (AQF-100, manufactured by Mitsuibishi Chemical Analytech Co., Ltd.) under the standard conditions of the analyzer. The dried porous particles are combusted, and the generated bromine is absorbed into an absorbent solution (aqueous hydrogen peroxide). The amount of bromide ions is determined using ion chromatography (ICS-1500, manufactured by DIONEX), and the content of bromide ions per dry mass of 1 kg of the porous particles is calculated.

As described above, in the washing step preceding the cross-linking step, it is preferable to wash the porous particles such that each of the measured amount of lithium ions and the measured amount of bromide ions becomes equal to or less than 2,000 mmol. The washing method is not particularly limited, and any of known washing methods can be used as long as the content of lithium ions and bromide ions can be reduced as intended.

As the washing step, rinsing may be performed once by using a wash solution containing a sufficient amount of water or may be performed two or more times by replacing the wash solution.

The number of times of rinsing, the amount of the wash solution used, the rinsing condition, and the like in the washing step can be appropriately determined in consideration of the necessary strength of the porous cellulose particles and the intended extent of reduction of the content of impurities.

After the cross-linking step, it is preferable to remove impurities such as the cross-linking agent and the solvent remaining in the porous cellulose particles forming a cross-linked structure by performing again the aforementioned washing step.

(IV-3) Freeze-Drying Step

In order to obtain dried porous cellulose particles by removing liquid components such as the wash solution and the solvent remaining in the obtained porous cellulose particles, a freeze-drying step of freeze-drying the porous cellulose particles so as to obtain freeze-dried porous cellulose particles may be additionally performed.

The freeze-drying step can include a solvent substitution step of substituting the solvent such as water contained in the porous cellulose particles with ethanol or the like by bringing the wet porous cellulose particles into contact with ethanol or the like and then performing a treatment for further substituting the solvent ethanol with t-butanol, and a freeze-drying step of freeze-drying the porous cellulose particles having undergone the solvent substitution step by a common method by freezing the particles at a temperature of equal to or less than −18° C.

If the freeze-drying step is performed as desired, it is possible to obtain dried porous cellulose particles not containing liquid components such as water and an organic solvent.

As will be described later, in a case where the specific surface area, pore size, and the like of the porous cellulose particles are measured, it is preferable to use the freeze-dried porous cellulose particles.

[Porous Cellulose Particles]

The porous cellulose particles of the present invention are porous cellulose particles obtained by the aforementioned method for manufacturing porous cellulose particles of the present invention.

The porous cellulose particles of the present invention are porous particles which have a uniform spherical shape, have pores formed by removing lithium bromide or the like from porous particles containing cellulose regenerated through the coagulation step in the spherical disperse phase, and have excellent mechanical strength.

The porous cellulose particles obtained by the manufacturing method of the present invention take a uniform spherical shape, have pores on the inside thereof, and have excellent mechanical strength. Therefore, the porous cellulose particles can be suitably used for various purposes.

Hereinafter, preferred physical properties of the porous cellulose particles of the present invention will be described.

[Volume Average Particle Size]

The size of the porous cellulose particles is not particularly limited, but is preferably equal to or greater than 1 μm and equal to or less than 2,000 μm in terms of a volume average particle size.

The volume average particle size of the porous cellulose particles is preferably equal to or greater than 5 μm, and more preferably equal to or greater than 10 μm. Furthermore, the volume average particle size of the porous cellulose particles is preferably equal to or less than 500 μm, more preferably equal to or less than 200 μm, and particularly preferably equal to or less than 150 μm.

In a case where the porous cellulose particles are used as, for example, a carrier of an adsorbent for purification, the volume average particle size thereof is preferably equal to or greater than 20 μm and equal to or less than 1,000 μm. It is preferable that the volume average particle size of the porous cellulose particles is equal to or greater than 20 μm because then the porous cellulose particles does not easily cause compaction. Furthermore, it is preferable that the volume average particle size of the porous cellulose particles is equal to or less than 2,000 μm because then the amount of the adsorbed substance to be purified can be increased in a case where the porous cellulose particles are used as a carrier of an adsorbent for purification.

The volume average particle size of the porous cellulose particles can be determined by measuring the particle sizes of 1,000 porous cellulose particles that are randomly selected. By capturing the micrograph of each of the porous particles, the particle size of each of the porous particles is stored as electronic data, and the data can be analyzed using image processing software such as IMAGE J manufactured by National Institutes of Health. As the particles to be imaged using a microscope, wet porous cellulose particles or freeze-dried porous cellulose particles are used.

In the present invention, unless otherwise specified, the volume average particle size is measured using wet porous cellulose particles dispersed in water. As the micrograph, an image is used which is obtained by capturing the image of a sample prepared by applying the aqueous dispersion of the porous cellulose particles onto a slide and covering the slide with a cover glass.

The volume average particle size of the porous cellulose particles can also be measured using a laser diffraction/scattering-type particle size distribution analyzer or the COULTER COUNTER.

In the present specification, as the particle size of the porous cellulose particles, the value is adopted which is obtained by analyzing the electronic data, which is obtained by capturing micrographs of the porous cellulose particles, by using the image processing software “IMAGE J” manufactured by National Institutes of Health.

[Average Pore Size]

The pore size of the porous cellulose particles of the present invention is preferably equal to or greater than 10 nm and equal to or less than 2,000 nm in terms of an average pore size. The pore size of the porous cellulose particles is more preferably equal to or greater than 20 nm and equal to or less than 1,000 nm, even more preferably equal to or greater than 50 nm and equal to or less than 800 nm, and particularly preferably equal to or greater than 50 nm and equal to or less than 600 nm.

In a case where the obtained porous cellulose particles having a pore size within the above range are used as a carrier of chromatography, a filtering material, or the like, a substance used as a sample is sufficiently diffused, and excellent adsorption performance is demonstrated because the porous cellulose particles has a large specific surface area as described below.

[Specific Surface Area]

The specific surface area of the porous cellulose particles is preferably equal to or greater than 140 m²/g, more preferably equal to or greater than 150 m²/g, even more preferably equal to or greater than 160 m²/g, and particularly preferably equal to or greater than 180 m²/g.

The upper limit of the specific surface area is not particularly limited. If the specific surface area is too large, the diffusion of a substance in the particles is hindered in some cases. Therefore, from the viewpoint of inhibiting the hindrance of the diffusion of a substance in the particles, the upper limit of the specific surface area is preferably equal to or less than 1,000 m²/g.

In a case where the specific surface area is equal to or greater than 140 m²/g, the adsorption performance is further improved in a case where the porous cellulose particles are used as, for example, a carrier of chromatography.

One of the great characteristics of the manufacturing method of the present invention is that the method makes it possible to prepare porous cellulose particles with any particle size and specific surface area by adjusting the respective conditions described above.

[Modulus of Elasticity]

Considering a case where the porous cellulose particles of the present invention are used as a filtering material or the like, it is preferable that the porous cellulose particles have excellent mechanical strength satisfying a level necessary for practical use.

In the present invention, the “mechanical strength” of the porous cellulose particles means strength that prevents the porous cellulose particles from being easily deformed due to pressure.

As a measure of the mechanical strength of the porous cellulose particles, for example, a modulus of elasticity can be used. The modulus of elasticity of the porous cellulose particles of the present invention is preferably equal to or greater than 8.0 MPa, more preferably equal to or greater than 8.5 MPa, and even more preferably equal to or greater than 9.0 MPa.

(Method for Measuring Modulus of Elasticity)

The modulus of elasticity of the porous cellulose particles can be measured by the following method.

By using a microhardness tester (microhardness tester FISCHERSCOPE (registered trademark) HM2000 (trade name) manufactured by Fischer Instruments) and a 200 μm×200 μm flat indenter, a compression test is performed on the aqueous dispersion of the porous cellulose particles at a compression rate of 1 μm/s, and the load at the time when the porous cellulose particles has a 5% strain is determined.

On a measurement plate of the microhardness tester, a glass plate provided with a border frame for holding a liquid is disposed, and the aqueous dispersion of the porous cellulose particles is disposed in the frame of the glass plate. Then, water is added thereto until the depth of water inside the frame becomes 1 mm, and in a state where the porous cellulose particles are completely immersed in water, the modulus of elasticity is measured. In the compression test using the microhardness tester, the radius of a single particle as a measurement target is measured using the attached microscope, and the relationship between an indentation depth and a load at the time when the flat indenter is pushed into the sample at 1 μm/sec is measured.

For calculating the modulus of elasticity, the Hertz's equation is used.

The Hertzian contact stress refers to a stress or pressure applied to an elastic contact portion between spherical surfaces, cylindrical surfaces, any curved surfaces, and the like. Provided that radii of two elastic spheres are denoted by R₁ and R₂ respectively; the modulus of longitudinal elasticity, that is, the modulus of elasticity in the present specification is denoted by E₁ and E₂ (Pa); the Poisson's ratio is denoted by ν₁ and ν₂; and the approach amount of two contact surfaces is denoted by δ (m), a contact force P (N) is represented by the following Equation (1).

$$P = \frac{4}{3} {δ}^{\frac{3}{2}} {\{ ( \frac{1}{{R}_{1}} + \frac{1}{{R}_{2}} ) {( \frac{1 - {v}_{1}^{2}}{{E}_{1}} + \frac{1 - {v}_{2}^{2}}{{E}_{2}} )}^{2} \}}^{- \frac{1}{2}} \qquad ( 1 )$$

In the present invention, the modulus of elasticity is measured at the time when the spherical surface of the porous cellulose particles comes into contact with the flat surface of the flat indenter, and in the Equation (1), flat indenter: E₂=∞, R₂=∞. Furthermore, the Poisson's ratio ν₁ of the porous cellulose particles equals 0.5. Considering the fact that the particles are compressed up and down, the approach amount δ is set to be 2.5% that is the half of the indentation depth 5%. In this way, the value of load measured at the time when the indentation rate is 5% is denoted by P (N), and the radius of the particle is plugged into R₁ (m), thereby calculating the modulus of elasticity E₁ (MPa) and taking it as a modulus of elasticity of the present invention.

[Ion Content]

It is preferable that the porous cellulose particles of the present invention contain a small amount of residual lithium ions and bromide ions, and the lower limit of the content of the ions is not particularly limited.

From the viewpoint of the mechanical strength of the obtained porous cellulose particles and the suitability of the particles for use such as antigen purification for which the particles must have a small amount of impurities, each of the content of residual lithium ions and the content of residual bromide ions in the porous cellulose particles of the present invention is preferably equal to or less than 100 mmol per 1 kg of dry particles, more preferably equal to or less than 50 mmol, and particularly preferably equal to or less than 1 mmol, for the following reason.

If at least any one of lithium ions or bromide ions remain in a large amount within the porous cellulose particles, for example, in a case where the porous cellulose particles are used as a carrier for adsorption, various chromatography carriers, and the like, the lithium ions or bromide ions remaining in the porous cellulose particles are likely to be mixed into the separated and purified substance and deteriorate the quality of the purified substance. In a case where ions as impurities are contained in the obtained purified substance, in order to reduce the content of the ions, the number of times the purified substance is washed needs to be increased, and hence the manufacturing costs are increased. Therefore, as described above, it is preferable that both of the content of lithium ions and the content of bromide ions in the porous cellulose particles is within a range of equal to or less than 100 mmol per 1 kg of the dried porous cellulose particles.

Each of the content of lithium ions and the content of bromide ions in the porous cellulose particles is preferably equal to or greater than 0.0001 mmol and equal to or less than 100 mmol per 1 kg of the dry particles.

Considering the productivity of the porous cellulose particles and the detection limit imposed in a case where the porous cellulose particles are measured using a general measurement device, each of the content of lithium ions and the content of bromide ions may be, per 1 kg of dry particles, equal to or greater than 0.01 mmol and equal to or less than 100 mmol, may be equal to or greater than 0.1 mmol and equal to or less than 100 mmol, or may be equal to or greater than 1 mmol and equal to or less than 100 mmol.

The dry porous cellulose particles used for measuring the content of lithium ions or bromide ions are dry porous cellulose particles prepared by substituting the solvent of the porous cellulose particles wet with water with acetone and drying the particles for 5 hours at 40° C.

The content of the residual lithium ions is measured using an ICP emission spectrometer (OPTIMA 7300 DV, manufactured by PerkinElmer Inc.) under the standard conditions of the spectrometer. The content of the residual lithium ions is measured by obtaining a solution by dissolving the dry porous cellulose particles in an acid (70% by mass aqueous nitric acid solution), and determining the amount of lithium ions in the obtained solution.

The content of the residual bromide ions is measured using a combustion-type halogen analyzer (AQF-100, manufactured by Mitsuibishi Chemical Analytech Co., Ltd.) under the standard conditions of the analyzer. The dry porous cellulose particles are combusted, the generated bromine is absorbed into an absorbent solution (aqueous hydrogen peroxide), and the amount of bromide ions in the adsorbent solution is measured. For determining the amount of bromide ions, ion chromatography (ICS-1500, manufactured by DIONEX) is used.

The novel porous cellulose particles of the present invention can be used as a carrier for various chromatography techniques such as ion exchange chromatography, affinity chromatography, size exclusion chromatography, and partition chromatography, an adsorbent, a carrier of a test drug or a bioreactor, a filler for light diffusion, a scaffolding material for cell culture, and the like.

### EXAMPLES

Hereinafter, the present invention will be more specifically described based on examples. However, as long as the scope of the present invention is maintained, the present invention is not limited to the following examples.

### Example 1

### Cellulose Solution Preparation Step

1.5 g of crystalline cellulose powder [KC FLOCK W-300G (trade name), average degree of polymerization: 370, manufactured by NIPPON PAPER INDUSTRIES CO., LTD.] was added to 50 g of a 60% by mass aqueous lithium bromide solution and dissolved by being heated to 110° C., thereby obtaining a cellulose solution.

(Dispersion Preparation Step)

As a surfactant, 0.3 g of sorbitan monooleate [SPAN 80 (trade name), manufactured by Wako Pure Chemical Industries, Ltd.] was dissolved in 270 mL of xylene as an organic dispersion medium, thereby preparing a dispersion medium. Then, the obtained dispersion medium was heated to 125° C., and the aforementioned cellulose solution preheated to 110° C. was added to the dispersion medium heated to 125° C., followed by stirring at a rotation frequency of 400 rpm. In a state of keeping the temperature of the dispersion medium at 125° C., stirring was continued for 10 minutes, thereby obtaining a dispersion.

(Cellulose Coagulation Step)

The obtained dispersion was cooled to room temperature (25° C.) approximately over 1 hour (cooling rate: 1.7° C./min). After cooling, the dispersion was continuously stirred in a state of maintaining the rotation frequency, and 250 mL of methanol as a coagulation solvent was added dropwise thereto over 10 minutes so as to coagulate the disperse phase in the dispersion. The coagulated disperse phase was subjected to suction filtration so as to remove the dispersion medium, washed with 100 mL of methanol, and then subjected to suction filtration, thereby obtaining porous particles in which cellulose was regenerated by coagulation.

(Washing Step)

The obtained porous particles were put into a beaker, 100 mL of distilled water was added thereto, and a rinsing treatment was performed in which the porous particles were washed by being stirred for 30 minutes. For stirring, a stirring blade made of TEFLON (registered trademark) (tetrafluoroethylene) was used. After stirring, the water used for washing was removed by suction filtration. The process described so far was taken as a single session of the rinsing treatment, and by performing the same rinsing treatment as described above twice, the washing step ended. After the rinsing treatment, the residual solvent and salt were removed, thereby obtaining purified wet coagulated particles, that is, non-cross-linked porous cellulose particles.

(Cross-Linking Step)

After the washing step, 10 mL of a 0.5 mol aqueous sodium hydroxide solution was added to 10 g of the wet porous particles, and the particles were heated to 45° C. for 10 minutes. Then, 20 mg of sodium borohydride (manufactured by Wako Pure Chemical Industries, Ltd.) and 10 mL of trimethylolpropane glycidyl ether (manufactured by Sigma-Aldrich Co, LLC.) as a cross-linking agent were added thereto and reacted for 3 hours at 45° C., thereby forming a cross-linked structure in the cellulose contained in the porous particles having undergone the rinsing treatment.

Thereafter, the reaction solution containing the porous cellulose particles in which the cross-linked structure was formed was subjected to suction filtration, thereby separating and obtaining the porous cellulose particles in which the cross-linked structure was formed. By performing the washing step of rinsing the obtained porous cellulose particles twice with 100 mL of distilled water, porous cellulose particles wet with water were obtained.

A micrograph of the aqueous dispersion of the porous cellulose particles wet with water was captured, and the volume average particle size was measured by the aforementioned method. As a result, it was confirmed that the obtained porous cellulose particles had a volume average particle size of 85 μm.

The obtained porous cellulose particles wet with water was subjected to acetone substitution and dried by being heated for 5 hours at 40° C., thereby obtaining 0.6 g of dry porous cellulose particles.

(Content of Lithium Ions and Bromide Ions in Porous Cellulose Particles Having Undergone Cross-Linking)

By using the dry porous cellulose particles obtained in Example 1 as a measurement target, the content of lithium ions and bromide ions remaining in the dry porous cellulose particles was measured. As a result, it was confirmed that the content of lithium ions was 0.82 mmol per 1 kg of the dry particles, and the content of bromide ions was 0.90 mmol per 1 kg of the dry particles.

### Example 2

Porous cellulose particles were obtained in the same manner as in Example 1, except that the 60% by mass aqueous lithium bromide solution used in the cellulose solution preparation step was replaced with a 55% by mass aqueous lithium bromide solution.

As a result, porous cellulose particles weighing 0.5 g in terms of dry mass were obtained. The volume average particle size of the porous cellulose particles measured in the same manner as in Example 1 was 80 μm.

### Example 3

Porous cellulose particles were obtained in the same manner as in Example 1, except that the 60% by mass aqueous lithium bromide solution used in the cellulose solution preparation step was replaced with a 67% by mass aqueous lithium bromide solution.

As a result, porous cellulose particles weighing 0.6 g in terms of dry mass were obtained. The volume average particle size measured in the same manner as in Example 1 was 96 μm.

### Example 4

Porous cellulose particles were obtained in the same manner as in Example 1, except that the amount of the crystalline cellulose powder used in the cellulose solution preparation step was changed to 1.0 g from 1.5 g.

As a result, porous cellulose particles weighing 0.4 g in terms of dry mass were obtained. The volume average particle size measured in the same manner as in Example 1 was 64 μm.

### Example 5

Porous cellulose particles were obtained in the same manner as in Example 1, except that the amount of the crystalline cellulose powder used in the cellulose solution preparation step was changed to 3.0 g from 1.5 g.

As a result, porous cellulose particles weighing 0.7 g in terms of dry mass were obtained. The volume average particle size measured in the same manner as in Example 1 was 136 μm.

### Example 6

Porous cellulose particles were obtained in the same manner as in Example 1, except that the crystalline cellulose powder used in the cellulose solution preparation step was replaced with [KC-FLOCK W-50G (trade name), average degree of polymerization: 820, manufactured by NIPPON PAPER INDUSTRIES CO., LTD].

As a result, porous cellulose particles weighing 0.6 g in terms of dry mass were obtained. The volume average particle size measured in the same manner as in Example 1 was 142 μm.

### Example 7

Porous cellulose particles were obtained in the same manner as in Example 1, except that methanol as a coagulation solvent in the coagulation step was replaced with tetrahydrofuran.

As a result, porous cellulose particles weighing 0.5 g in terms of dry mass were obtained. The volume average particle size measured in the same manner as in Example 1 was 82 μm.

### Example 8

Porous cellulose particles were obtained in the same manner as in Example 1, except that xylene as an organic dispersion medium used in the dispersion preparation step was replaced with dichlorobenzene.

As a result, porous cellulose particles weighing 0.5 g in terms of dry mass were obtained. The volume average particle size measured in the same manner as in Example 1 was 80 μm.

### Example 9

Porous cellulose particles were obtained in the same manner as in Example 1, except that xylene as an organic dispersion medium used in the dispersion preparation step was replaced with dichlorobenzene, and methanol as a coagulation solvent in the coagulation step was replaced with isopropanol.

As a result, porous cellulose particles weighing 0.6 g in terms of dry mass were obtained. The volume average particle size measured in the same manner as in Example 1 was 84 μm.

### Example 10

Porous cellulose particles were obtained in the same manner as in Example 1, except that xylene as an organic dispersion medium used in the dispersion preparation step was replaced with olive oil, and the coagulation solvent in the coagulation step was replaced with acetone.

As a result, porous cellulose particles weighing 0.5 g in terms of dry mass were obtained. The volume average particle size measured in the same manner as in Example 1 was 32 μm.

### Example 11

Porous cellulose particles were obtained in the same manner as in Example 1, except that xylene as an organic dispersion medium used in the dispersion preparation step was replaced with glyceryl trioctanoate, and methanol as a coagulation solvent in the coagulation step was replaced with ethanol.

As a result, porous cellulose particles weighing 0.6 g in terms of dry mass were obtained. The volume average particle size measured in the same manner as in Example 1 was 75 μm.

### Example 12

Porous cellulose particles were obtained in the same manner as in Example 1, except that xylene as an organic dispersion medium used in the dispersion preparation step was replaced with silicone oil, and methanol as a coagulation solvent in the coagulation step was replaced with methyl ethyl ketone.

As a result, porous cellulose particles weighing 0.5 g in terms of dry mass were obtained. The volume average particle size measured in the same manner as in Example 1 was 72 μm.

### Example 13

A dispersion was prepared in the same manner as in Example 1, except that xylene as an organic dispersion medium used in the dispersion preparation step was replaced with dichlorobenzene, and the dispersion was cooled to room temperature (25° C.) in the same manner as in Example 1. Then, most of the dispersion medium was removed by suction filtration, and the disperse phase was dipped in 250 mL of distilled water as a coagulation solvent, followed by gentle stirring for 10 minutes. Thereafter, water was removed by performing suction filtration again on the coagulated disperse phase, thereby obtaining a coagulated disperse phase.

The obtained coagulated disperse phase was washed with methanol and then rinsed with distilled water so as to remove the residual solvent and salt, thereby obtaining wet porous cellulose particles. Then, the cross-linking step was performed in the same manner as in Example 1, thereby obtaining porous cellulose particles.

As a result, porous cellulose particles weighing 0.8 g in terms of dry mass were obtained. The volume average particle size measured in the same manner as in Example 1 was 75 μm.

### Comparative Example 1

1.5 g of crystalline cellulose powder [KC-FLOCK W-300G (trade name), average degree of polymerization: 370, manufactured by NIPPON PAPER INDUSTRIES CO., LTD.] was added to 50 g of a 60% by mass aqueous calcium thiocyanate solution and dissolved by being heated to 100° C.

As a surfactant, 0.3 g of sorbitan moonoleate [SPAN 80 (trade name), manufactured by Wako Pure Chemical Industries, Ltd.] was dissolved in 270 mL of dichlorobenzene as an organic dispersion medium, thereby preparing a dispersion medium. Then, the obtained dispersion medium was heated to 130° C., and the cellulose solution preheated to 100° C. was added to the heated dispersion medium, followed by stirring at a rotation frequency of 400 rpm, thereby preparing a dispersion. In a state of keeping the temperature of the dispersion at 130° C., stirring was continued for 10 minutes.

The obtained dispersion was cooled to room temperature at a cooling rate of 2° C./min. After cooling, the dispersion was continuously heated in a state of maintaining the rotation frequency at 400 rpm, and 250 mL of methanol as a coagulation solvent was added dropwise thereto over 10 minutes, thereby coagulating the disperse phase in the dispersion.

By performing suction filtration on the coagulated disperse phase, the dispersion medium was removed, thereby obtaining a coagulated disperse phase. The obtained coagulated disperse phase was washed with methanol and then rinsed with distilled water so as to remove the residual solvent and salt, thereby obtaining wet porous particles. Then, the same cross-linking operation as in Example 1 was performed.

As a result, porous cellulose particles weighing 0.5 g in terms of dry mass were obtained. The volume average particle size measured in the same manner as in Example 1 was 255 μm.

### Comparative Example 2

12 g of cellulose diacetate [L-70 (trade name), average degree of polymerization: 190, manufactured by DAICEL CORPORATION] was dissolved in a mixed solvent of 80 mL of dichloromethane and 20 mL of methanol, thereby preparing a cellulose diacetate solution with a concentration of 9% by mass.

By adding 1-octanol [manufactured by Wako Pure Chemical Industries, Ltd.] to the obtained cellulose diacetate solution, a mixed solution was prepared. The obtained mixed solution was added to 400 mL of a gelatin-containing aqueous medium with a concentration of about 5% by mass that was put into a round-bottom flask, followed by stirring at a stirring rate of 150 rpm, thereby preparing a suspension. The obtained suspension was heated to 35° C. and continuously stirred in a state of keeping the temperature at 35° C., thereby evaporating and removing dichloromethane contained in the suspended particles.

The solid content in the obtained suspension was subjected to suction filtration so as to separate and remove the residual aqueous medium or the like, thereby obtaining spherical cellulose diacetate particles. The alcohol-containing diluent contained in the obtained spherical cellulose diacetate particles was removed by washing the particles with methanol.

The washed spherical cellulose diacetate particles were saponified in 250 mL of a aqueous sodium hydroxide solution with a concentration of 2 mol/L (liter) containing 10% by volume of methanol.

As a result, porous cellulose particles weighing 10.2 g in terms of dry mass were obtained. The volume average particle size measured in the same manner as in Example 1 was 480 μm.

[Evaluation of Porous Cellulose Particles]

The obtained porous cellulose particles of Examples 1 to 13 and Comparative Examples 1 and 2 were evaluated according to the following criteria. The results are shown in the following Tables 1 to 3.

1. Measurement of Volume Average Particle Size

By the method described above, micrographs of the porous cellulose particles obtained in each of the examples and comparative examples were captured using an aqueous dispersion of 1,000 porous cellulose particles that were randomly selected, and stored as electronic data. Then, by using the software IMAGE J manufactured by National Institutes of Health, the volume average particle size thereof was calculated.

2. Measurement of Pore Size

2-1. Preparation of Freeze-Dried Particles

The wet porous cellulose particles obtained in the examples and comparative examples subjected to a substitution treatment by sequentially using a 50% by volume aqueous ethanol solution, a 70% by volume aqueous ethanol solution, a 95% by volume aqueous ethanol solution, and a 100% by volume aqueous ethanol solution, and ethanol was substituted again with t-butanol, followed by freezing (at a temperature of equal to or less than −18° C.). Thereafter, by performing freeze-drying, freeze-dried particles for measuring pores were obtained.

2-2. Imaging Surface Pore Shape

For imaging, the obtained freeze-dried particles were subjected to a vapor deposition treatment using osmium, and images (magnification: 200× and 30,000×) of the porous cellulose particles having undergone the vapor deposition treatment were captured using a scanning electron microscope (SEM).

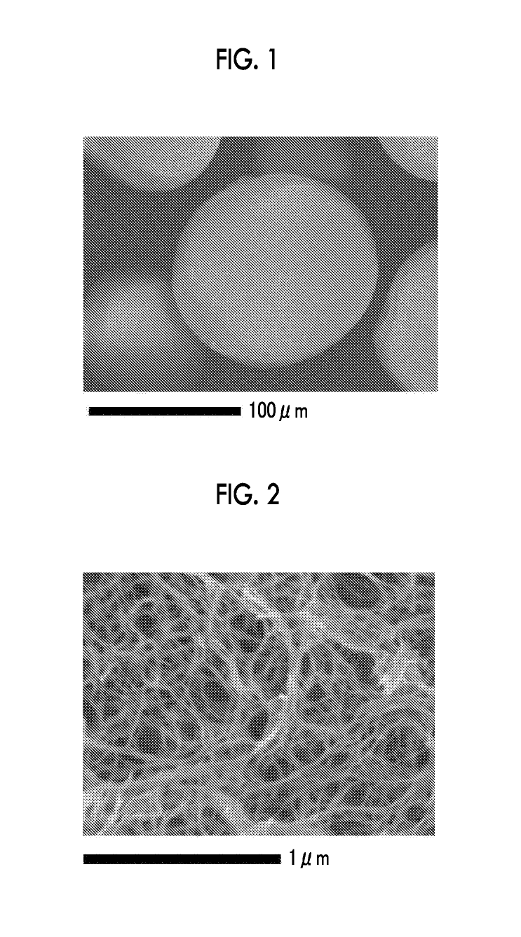

FIG. 1 is a scanning electron micrograph of the porous cellulose particles obtained in Example 10 that was imaged under 200× magnification, and FIG. 2 is a scanning electron micrograph of the porous cellulose particles obtained in Example 10 that was imaged under 30,000× magnification. As is evident from the scanning electron micrographs, the obtained freeze-dried particles are spherical particles and has fine pores on the inside thereof.

2-3. Measurement of Average Pore Size, Maximum Pore Size, and Specific Surface Area

By using the obtained freeze-dried particles, the distribution of pores was analyzed by mercury intrusion porosimetry using a pore distribution analyzer MICROMERITICS AUTOPORE 9520 (trade name) manufactured by Shimadzu Corporation.

As a sample, 0.05 g of the freeze-dried porous cellulose particles were weighted out into a cell having a volume of 5 mL and measured at an initial pressure of about 5 kPa. The calculated median diameter was taken as an average pore size. In the obtained pore distribution, the greatest value of the detected pore size was taken as a maximum pore size. Furthermore, from the obtained pore distribution, a surface area per unit mass was calculated, and the obtained value was taken as a specific surface area of the porous cellulose particles.

TABLE 1

| | | Example 1 | Example 2 | Example 3 | Example 4 | Example 5 |
|---|---|---|---|---|---|---|
| Raw material | Cellulose | Crystalline | Crystalline | Crystalline | Crystalline | Crystalline |
| | (degree of | cellulose | cellulose | cellulose | cellulose | cellulose |
| | polymerization) | (370) | (370) | (370) | (370) | (370) |
| | Cellulose | 1.5 g | 1.5 g | 1.5 g | 1.0 g | 3.0 g |
| | (used amount) | | | | | |
| | Solution for | 60% by mass | 55% by mass | 67% by mass | 60% by mass | 60% by mass |
| | dissolving | aqueous | aqueous | aqueous | aqueous | aqueous |
| | cellulose | lithium | lithium | lithium | lithium | lithium |
| | | bromide | bromide | bromide | bromide | bromide |
| | | solution | solution | solution | solution | solution |
| | Organic | Xylene | Xylene | Xylene | Xylene | Xylene |
| | dispersion | | | | | |
| | medium | | | | | |
| | Coagulation | Methanol | Methanol | Methanol | Methanol | Methanol |
| | solvent | | | | | |
| Physical | Volume average | 85 | 80 | 96 | 64 | 136 |
| properties of | particle size | | | | | |
| porous | (μm) | | | | | |
| cellulose | Specific surface | 204 | 222 | 186 | 194 | 220 |
| particles | area | | | | | |
| | (m²/g) | | | | | |
| | Average pore size | 430 | 370 | 510 | 520 | 250 |
| | (nm) | | | | | |
| | Maximum pore | 1320 | 1040 | 1550 | 1720 | 820 |
| | size | | | | | |
| | (nm) | | | | | |

TABLE 2

| | | | Example | | Comparative | |
|---|---|---|---|---|---|---|
| | | Example 11 | 12 | Example 13 | Example 1 | Comparative Example 2 |
| Raw | Cellulose | Crystalline | Crystalline | Crystalline | Crystalline | Cellulose diacetate |
| material | (degree of | cellulose | cellulose | cellulose | cellulose | (190) |
| | polymerization) | (370) | (370) | (370) | (370) | |
| | Cellulose | 1.5 g | 1.5 g | 1.5 g | 1.5 g | 12 g |
| | (used amount) | | | | | |
| | Solution for | 60% by | 60% by | 60% by mass | 60% by mass | Dichloromethane/Methanol |
| | dissolving | mass | mass | aqueous lithium | aqueous calcium | (80/20) |
| | cellulose | aqueous | aqueous | bromide solution | thiocyanate | |
| | | lithium | lithium | | solution | |
| | | bromide | bromide | | | |
| | | solution | solution | | | |
| | Organic | Glyceryl | Silicone | Dichlorobenzene | Dichlorobenzene | 5% aqueous gelatin |
| | dispersion | trioctanoate | oil | | | solution |
| | medium | | | | | |
| | Coagulation | Ethanol | Methyl | Water | Methanol | — |
| | solvent | | ethyl | | | |
| | | | ketone | | | |
| Physical | Volume average | 75 | 72 | 75 | 255 | 480 |
| properties | particle size | | | | | |
| of porous | (μm) | | | | | |
| cellulose | Specific surface | 184 | 152 | 205 | 136 | 16 |
| particles | area | | | | | |
| | (m²/g) | | | | | |
| | Average pore | 490 | 520 | 260 | 620 | 3500 |
| | size | | | | | |
| | (nm) | | | | | |
| | Maximum pore | 1600 | 1640 | 870 | 2400 | 8800 |
| | size | | | | | |
| | (nm) | | | | | |

TABLE 3

| | | Example 6 | Example 7 | Example 8 | Example 9 | Example 10 |
|---|---|---|---|---|---|---|
| Raw | Cellulose | Crystalline | Crystalline | Crystalline | Crystalline | Crystalline |
| material | (degree of | cellulose | cellulose | cellulose | cellulose | cellulose |
| | polymerization) | (820) | (370) | (370) | (370) | (370) |
| | Cellulose | 1.5 g | 1.5 g | 1.5 g | 1.5 g | 1.5 g |
| | (used amount) | | | | | |
| | Solution for | 60% by mass | 60% by mass | 60% by mass | 60% by mass | 60% by mass |
| | dissolving | aqueous | aqueous lithium | aqueous lithium | aqueous lithium | aqueous |
| | cellulose | lithium | bromide solution | bromide solution | bromide solution | lithium |
| | | bromide | | | | bromide |
| | | solution | | | | solution |
| | Organic | Xylene | Xylene | Dichlorobenzene | Dichlorobenzene | Olive oil |
| | dispersion | | | | | |
| | medium | | | | | |
| | Coagulation | Methanol | Tetrahydrofuran | Methanol | Isopropanol | Acetone |
| | solvent | | | | | |
| Physical | Volume average | 142 | 82 | 80 | 84 | 32 |
| properties | particle size | | | | | |
| of porous | (μm) | | | | | |
| cellulose | Specific surface | 184 | 174 | 216 | 164 | 178 |
| particles | area | | | | | |
| | (m²/g) | | | | | |
| | Average pore | 420 | 520 | 420 | 480 | 460 |
| | size | | | | | |
| | (nm) | | | | | |
| | Maximum pore | 1370 | 1620 | 1300 | 1520 | 1580 |
| | size | | | | | |
| | (nm) | | | | | |

From the results shown in Tables 1 to 3, it is understood that the porous cellulose particles obtained by the manufacturing method of the present invention have a fine pore size and a large specific surface area, and accordingly, the porous cellulose particles can be suitably used for various purposes such as a carrier of chromatography and a filtering material.

In contrast, it is understood that, in the porous cellulose particles obtained by the method of comparative examples, both of the particle size and the pore size are greater than in examples, and the specific surface area is smaller than in examples.

### Example 14

1.5 g of crystalline cellulose powder [KC FLOCK W-300G (trade name), average degree of polymerization: 370, manufactured by NIPPON PAPER INDUSTRIES CO., LTD.] was added to 50 g of a 60% by mass aqueous lithium bromide solution and dissolved by being heated to 110° C., thereby obtaining a cellulose solution. By using the cellulose solution, the steps from the solution preparation step to the washing step were performed in the same manner as in Example 1, thereby obtaining wet porous particles.

A treatment was performed in which the solvent of the porous particles having undergone the washing step was substituted with ethanol and then the solvent ethanol was substituted again with t-butanol, and the particles were freezed at a temperature of equal to or less than −18° C., thereby obtaining dry porous particles having undergone freeze-drying by a common method. By the method described above, the content of the residual lithium ions and bromide ions in the obtained dry porous particles was measured. As a result, it was confirmed that the content of lithium ions was 40 mmol per 1 kg of the dry porous particles, and the content of bromide ions was 46 mmol per 1 kg of the dry porous particles.

(Cross-Linking Step)

10 mL of a 0.5 mol aqueous sodium hydroxide solution was added to 10 g of the wet porous particles having undergone the washing step, and heated to 45° C. for 10 minutes. Then, 20 mg of sodium borohydride (manufactured by Wako Pure Chemical Industries, Ltd.) and 10 mL of epichlorohydrin (manufactured by Wako Pure Chemical Industries, Ltd.) as a cross-linking agent were added thereto and reacted for 3 hours at 45° C., thereby forming a cross-linked structure in the porous particles.

Thereafter, the reaction solution containing coagulated particles in which the cross-linked structure was formed were subjected to suction filtration, thereby separating and obtaining porous particles in which the cross-linked structure was formed. By performing the washing step of rinsing the obtained porous particles twice with 100 mL of distilled water, porous cellulose particles wet with water were obtained.

The obtained porous cellulose particles wet with water were freeze-dried in the same manner as used for obtaining the dry porous particles, thereby obtaining freeze-dried porous cellulose particles. The obtained dry porous cellulose particles weighed 0.6 g in terms of dry mass. The volume average particle size of the porous cellulose particles measured in the same manner as in Example 1 was 85 μm.

### Examples 15 to 25

Porous cellulose particles of Examples 15 to 25 were obtained in the same manner as in Examples 2 to 12, except that the cross-linking agent in the cross-linking step was changed to epichlorohydrin from trimethylolpropane triglycidyl ether, and dry porous cellulose particles were obtained by using a method of drying the particles by freeze-drying in the same manner as in Example 14 instead of the method of performing acetone substitution and heating the particles to 40° C. for 5 hours.

### Example 26

A dispersion was prepared in the same manner as in Example 14, except that xylene as an organic dispersion medium used in the dispersion preparation step was replaced with dichlorobenzene. Then, the dispersion was cooled to room temperature (25° C.) in the same manner as in Example 14. Thereafter, most of the dispersion medium was removed by suction filtration, and the disperse phase was dipped in 250 mL of distilled water as a coagulation solvent, followed by gentle stirring for 10 minutes, thereby forming porous particles in which the dispersion phase coagulated. The dispersion containing the porous particle were subjected to suction filtration so as to remove the dispersion medium, and then the separated and obtained porous particles were washed with 100 mL of methanol, followed by suction filtration, thereby obtaining porous particles.

Subsequently, the washing step and the cross-linking step were performed in the same manner as in Example 14, thereby obtaining porous cellulose particles.

The obtained porous cellulose particles weighed 0.8 g in terms of dry mass, and the volume average particle size thereof measured in the same manner as in Example 1 was 75 μm.

### Comparative Example 3

1.5 g of crystalline cellulose powder [KC FLOCK W-300G (trade name), average degree of polymerization: 370, manufactured by NIPPON PAPER INDUSTRIES CO., LTD.] was added to 50 g of a 60% by mass aqueous lithium bromide solution and dissolved by being heated to 110° C., thereby obtaining a cellulose solution. By using the cellulose solution, the steps from the solution preparation step to the washing step were performed in the same manner as in Comparative Example 1, thereby obtaining wet porous particles.

The porous particles were subjected to suction filtration so as to remove the dispersion medium and then washed with 100 mL of methanol, followed by suction filtration, thereby obtaining wet porous particles. The obtained porous particles were put into a beaker, 100 mL of distilled water was added thereto, and the washing step of performing a rinsing treatment by stirring the particles for 30 minutes was performed. For stirring, a stirring blade made of tetrafluoroethylene was used. After stirring, the water used for washing was removed by suction filtration. The process described so far was taken as a single session of the rinsing treatment, and the rinsing treatment was performed twice herein. The residual solvent and salt were removed, thereby obtaining washed wet porous particles.

Thereafter, the obtained porous particles were subjected to the cross-linking step in the same manner as in Example 14, thereby obtaining porous cellulose particles in the same manner as in Example 14.

The obtained porous cellulose particles weighed 0.5 g in terms of dry mass, and the volume average particle size thereof measured in the same manner as in Example 1 was 255 μm.

[Evaluation of Porous Cellulose Particles]

According to the following criteria, the modulus of elasticity of the obtained porous cellulose particles of Examples 14 to 26 and Comparative Example 3 was evaluated. Furthermore, the content of lithium ions and bromide ions contained in the dry porous particles having undergone the washing step preceding the cross-linking step was measured by the method described above.

In addition, the volume average particle size, the specific surface area, the average pore size, and the maximum pore size of the porous cellulose particles were measured in the same manner as in Example 1.

The evaluation results are shown in the following Tables 4 to 6.

[Modulus of Elasticity]

By using a microhardness tester (microhardness tester FISCHERSCOPE (registered trademark) HM2000 (trade name) manufactured by Fischer Instruments) and a 200 μm×200 μm flat indenter, the modulus of elasticity of the obtained porous cellulose particles was measured at a compression rate of 1 μm/s. The modulus of elasticity was measured according to the “Method for measuring modulus of elasticity” described above.

For measuring the modulus of elasticity using the microhardness tester, different samples were tested 10 times by changing the aqueous dispersion of the porous cellulose particles, and the obtained moduli of elasticity were averaged. The obtained value was taken as the modulus of elasticity of the porous cellulose particles in the present specification.

The results are shown in the following Tables 4 to 6.

TABLE 4

| | Example 14 | Example 15 | Example 16 | Example 17 |
|---|---|---|---|---|
| Cellulose | Crystalline | Crystalline | Crystalline | Crystalline |
| (degree of | cellulose | cellulose | cellulose | cellulose |
| polymerization) | (370) | (370) | (370) | (370) |
| Cellulose | 1.5 g | 1.5 g | 1.5 g | 1.0 g |
| (used amount) | | | | |
| Solution for | 60% by mass | 55% by mass | 67% by mass | 60% by mass |
| dissolving cellulose | aqueous lithium | aqueous lithium | aqueous lithium | aqueous lithium |
| | bromide solution | bromide solution | bromide solution | bromide solution |
| Dispersion solvent | Xylene | Xylene | Xylene | Xylene |
| Coagulation solvent | Methanol | Methanol | Methanol | Methanol |
| Rinsing condition | 100 mL/twice | 100 mL/twice | 100 mL/twice | 100 mL/twice |
| Amount of | | | | |
| water/number of | | | | |
| times | | | | |
| Cross-linking step | Performed | Performed | Performed | Performed |
| Order of steps | Rinsing → | Rinsing → | Rinsing → | Rinsing → |
| | Cross-linking | Cross-linking | Cross-linking | Cross-linking |
| Particles before | 40 | 37 | 64 | 42 |
| cross-linking step | | | | |
| Lithium ion | | | | |
| concentration | | | | |
| (mmol/kg) | | | | |
| Particles before | 46 | 42 | 69 | 51 |
| cross-linking step | | | | |
| Bromide ion | | | | |
| concentration | | | | |
| (mmol/kg) | | | | |
| Modulus of | 9.2 | 8.3 | 9.7 | 8.1 |
| elasticity | | | | |
| (MPa) | | | | |
| Volume average | 85 | 80 | 96 | 64 |
| particle size | | | | |
| (μm) | | | | |
| Specific surface area | 204 | 222 | 186 | 194 |
| (m²/g) | | | | |
| Average pore size | 430 | 370 | 510 | 520 |
| (nm) | | | | |
| Maximum pore size | 1320 | 1040 | 1550 | 1720 |
| (nm) | | | | |

TABLE 5

| | Example 18 | Example 19 | Example 20 | Example 21 | Example 22 |
|---|---|---|---|---|---|
| Cellulose | Crystalline | Crystalline | Crystalline | Crystalline | Crystalline |
| (degree of | cellulose | cellulose | cellulose | cellulose | cellulose |
| polymerization) | (370) | (820) | (370) | (370) | (370) |
| Cellulose | 3.0 g | 1.5 g | 1.5 g | 1.5 g | 1.5 g |
| (used amount) | | | | | |
| Solution for | 60% by mass | 60% by mass | 60% by mass | 60% by mass | 60% by mass |
| dissolving cellulose | aqueous lithium | aqueous lithium | aqueous lithium | aqueous lithium | aqueous lithium |
| | bromide solution | bromide solution | bromide solution | bromide solution | bromide solution |
| Dispersion solvent | Xylene | Xylene | Xylene | Dichlorobenzene | Dichlorobenzene |
| Coagulation solvent | Methanol | Methanol | Tetrahydrofuran | Methanol | Isopropanol |
| Rinsing condition | 100 mL/twice | 100 mL/twice | 100 mL/twice | 100 mL/twice | 100 mL/twice |
| Amount of | | | | | |
| water/number of | | | | | |
| times | | | | | |
| Cross-linking step | Performed | Performed | Performed | Performed | Performed |
| Order of steps | Rinsing → | Rinsing → | Rinsing → | Rinsing → | Rinsing → |
| | Cross-linking | Cross-linking | Cross-linking | Cross-linking | Cross-linking |
| Particles before | 58 | 62 | 53 | 72 | 75 |
| cross-linking step | | | | | |
| Lithium ion | | | | | |
| concentration | | | | | |
| (mmol/kg) | | | | | |
| Particles before | 63 | 72 | 55 | 75 | 80 |
| cross-linking step | | | | | |
| Bromide ion | | | | | |
| concentration | | | | | |
| (mmol/kg) | | | | | |
| Modulus of | 13.6 | 11.2 | 10.4 | 9.1 | 9.1 |
| elasticity | | | | | |
| (MPa) | | | | | |
| Volume average | 136 | 142 | 82 | 80 | 84 |
| particle size | | | | | |
| (μm) | | | | | |
| Specific surface area | 220 | 184 | 174 | 216 | 164 |
| (m²/g) | | | | | |
| Average pore size | 250 | 420 | 520 | 420 | 480 |
| (nm) | | | | | |
| Maximum pore size | 820 | 1370 | 1620 | 1300 | 1520 |
| (nm) | | | | | |

TABLE 6

| | | | | | Comparative |
|---|---|---|---|---|---|
| | Example 23 | Example 24 | Example 25 | Example 26 | Example 3 |
| Cellulose | Crystalline | Crystalline | Crystalline | Crystalline | Crystalline |
| (degree of | cellulose | cellulose | cellulose | cellulose | cellulose |
| polymerization) | (370) | (370) | (370) | (370) | (370) |
| Cellulose | 1.5 g | 1.5 g | 1.5 g | 1.5 g | 1.5 g |
| (used amount) | | | | | |
| Solution for | 60% by mass | 60% by mass | 60% by mass | 60% by mass | 60% by mass |
| dissolving cellulose | aqueous lithium | aqueous lithium | aqueous lithium | aqueous lithium | aqueous calcium |
| | bromide solution | bromide solution | bromide solution | bromide solution | thiocyanate solution |
| Dispersion solvent | Olive oil | Glyceryl | Silicone oil | Dichlorobenzene | Dichlorobenzene |
| | | trioctanoate | | | |
| Coagulation solvent | Acetone | Ethanol | Methyl ethyl | Water | Methanol |
| | | | ketone | | |
| Rinsing condition | 100 mL/twice | 100 mL/twice | 100 mL/twice | 100 mL/twice | 100 mL/twice |
| Amount of | | | | | |
| water/number of | | | | | |
| times | | | | | |
| Cross-linking step | Performed | Performed | Performed | Performed | Performed |
| Order of steps | Rinsing → | Rinsing → | Rinsing → | Rinsing → | Rinsing → |
| | Cross-linking | Cross-linking | Cross-linking | Cross-linking | Cross-linking |
| Particles before | 45 | 59 | 54 | 28 | — |
| cross-linking step | | | | | |
| Lithium ion | | | | | |
| concentration | | | | | |
| (mmol/kg) | | | | | |
| Particles before | 50 | 63 | 55 | 34 | — |
| cross-linking step | | | | | |
| Bromide ion | | | | | |
| concentration | | | | | |
| (mmol/kg) | | | | | |
| Modulus of | 10.4 | 8.6 | 9.1 | 8.4 | 7.6 |
| elasticity | | | | | |
| (MPa) | | | | | |
| Volume average | 32 | 75 | 72 | 75 | 255 |
| particle size | | | | | |
| (μm) | | | | | |
| Specific surface area | 178 | 184 | 152 | 205 | 136 |
| (m²/g) | | | | | |
| Average pore size | 460 | 490 | 520 | 260 | 620 |
| (nm) | | | | | |
| Maximum pore size | 1580 | 1600 | 1640 | 870 | 2400 |
| (nm) | | | | | |

From the results shown in Tables 4 to 6, it is understood that the porous cellulose particles of Examples 14 to 26 obtained by the manufacturing method of the present invention have a fine pore size, a large specific surface area, and a small maximum pore size. It is also understood that because the porous cellulose particles have a modulus of elasticity of equal to or greater than 8 MPa and have excellent mechanical strength, they can be suitably used for various purposes such as a carrier of chromatography and a filtering material.

In contrast, it is understood that the porous cellulose particles obtained by the method of Comparative Example 3 using calcium thiocyanate for preparing the cellulose solution do not exhibit sufficient mechanical strength even if a cross-linked structure is formed, have a pore size greater than that of examples and a specific surface area smaller than that of examples.

In addition, it is understood that the mechanical strength of the porous cellulose particles is better in Example 18 using a large amount of cellulose, Example 19 using cellulose with a higher degree of polymerization, and Example 23 using olive oil as a dispersion medium, than in Example 14.

### Example 27

### Cellulose Solution Preparation Step

2.5 g of crystalline cellulose powder [CEOLUS (registered trademark) PH-101, average degree of polymerization: 220, manufactured by Asahi Kasei Chemicals Corporation.] was added to 50 g of a 60% by mass aqueous lithium bromide solution and dissolved by being heated to 110° C., thereby preparing a cellulose solution.

(Dispersion Preparation Step)

As a surfactant, 0.3 g of sorbitan monooleate [SPAN 80 (trade name), manufactured by Wako Pure Chemical Industries, Ltd.] was dissolved in 270 mL of dichlorobenzene as an organic dispersion medium, thereby preparing a dispersion medium. Then, the obtained dispersion medium was heated to 125° C., and the aforementioned cellulose solution preheated to 110° C. was added to the dispersion medium heated to 125° C., followed by stirring at a rotation frequency of 400 rpm. In a state of keeping the temperature of the dispersion medium at 125° C., stirring was continued for 10 minutes, thereby obtaining a dispersion.

(Cellulose Coagulation Step)

The obtained dispersion was cooled to room temperature (25° C.) approximately over 1 hour (cooling rate: 1.7° C./min). After cooling, the dispersion was continuously stirred in a state of maintaining the rotation frequency at 400 rpm, and 250 mL of methanol as a coagulation solvent was added dropwise thereto over 10 minutes so as to coagulate the disperse phase in the dispersion.

The dispersion containing the coagulated disperse phase was subjected to suction filtration so as to remove the dispersion medium, washed with 100 mL of methanol, and then subjected to suction filtration, thereby obtaining wet porous particles.

(Washing Step)

The obtained wet porous particles were put into a beaker, 100 mL of distilled water was added thereto, and a washing step of performing a rinsing treatment by stirring the particles for 30 minutes was performed. For stirring, a stirring blade made of tetrafluoroethylene was used. After stirring, the water used for washing was removed by suction filtration. The process described so far was taken as a single session of the rinsing treatment, and the rinsing treatment was performed twice herein. The residual solvent and salt were removed, thereby obtaining coagulated particles containing wet cellulose.

(Cross-Linking Step)

10 mL of a 0.5 mol aqueous sodium hydroxide solution was added to 10 g of the wet porous particles, and the particles were heated to 45° C. for 10 minutes. Then, 20 mg of sodium borohydride (manufactured by Wako Pure Chemical Industries, Ltd.) and 10 mL of epichlorohydrin (manufactured by Wako Pure Chemical Industries, Ltd.) as a cross-linking agent were added thereto and reacted for 3 hours at 45° C., thereby obtaining porous cellulose particles in which a cross-linked structure is formed in porous particles.

Thereafter, the reaction solution containing the porous cellulose particles in which the cross-linked structure was formed was subjected to suction filtration, thereby separating and obtaining the porous cellulose particles in which the cross-linked structure was formed. By washing the obtained porous cellulose particles twice with 100 mL of distilled water, porous cellulose particles wet with water were obtained. By the method described above, the wet cellulose particles were freeze-dried, thereby preparing freeze-dried particles weighing 1.1 g in terms of dry mass. The volume average particle size of the obtained porous cellulose particles was measured in the same manner as in Example 1, and as a result, it was confirmed that the volume average particle size was 186 μm.

### Example 28

Porous cellulose particles were obtained in the same manner as in Example 27, except that dichlorobenzene as an organic dispersion medium used in the dispersion preparation step was replaced with liquid paraffin, and methanol as a coagulation solvent used in the coagulation step was replaced with tetrahydrofuran.

As a result, porous cellulose particles weighing 1.2 g in terms of dry mass were obtained. The volume average particle size thereof measured in the same manner as in Example 1 was 78 μm.

### Example 29

Porous cellulose particles were obtained in the same manner as in Example 28, except that the cross-linking step was not performed.

As a result, porous cellulose particles weighing 1.1 g in terms of dry mass were obtained. The volume average particle size thereof measured in the same manner as in Example 1 was 86 μm.

### Example 30

Porous cellulose particles were obtained in the same manner as in Example 28, except that the cross-linking step was repeated twice.

As a result, porous cellulose particles weighing 1.3 g in terms of dry mass were obtained. The volume average particle size thereof measured in the same manner as in Example 1 was 80 μm.

### Example 31

Porous cellulose particles were obtained in the same manner as in Example 28, except that the amount of crystalline cellulose powder used in the cellulose solution preparation step was changed to 1.5 g from 2.5 g.

As a result, porous cellulose particles weighing 0.7 g in terms of dry mass were obtained. The volume average particle size thereof measured in the same manner as in Example 1 was 46 μm.

### Example 32

Porous cellulose particles were obtained in the same manner as in Example 28, except that the amount of crystalline cellulose powder used in the cellulose solution preparation step was changed to 3.5 g from 2.5 g.

As a result, porous cellulose particles weighing 1.8 g in terms of dry mass were obtained. The volume average particle size thereof measured in the same manner as in Example 1 was 94 μm.

### Example 33

Porous cellulose particles were obtained in the same manner as in Example 28, except that liquid paraffin as an organic dispersion medium used in the dispersion preparation step was replaced with olive oil, and tetrahydrofuran as a coagulation solvent in the coagulation step was replaced with acetone.

As a result, porous cellulose particles weighing 1.3 g in terms of dry mass were obtained. The volume average particle size thereof measured in the same manner as in Example 1 was 95 μm.

### Example 34

Porous cellulose particles were obtained in the same manner as in Example 28, except that liquid paraffin as an organic dispersion medium used in the dispersion preparation step was replaced with sesame oil, and tetrahydrofuran as a coagulation solvent in the coagulation step was replaced with acetone.

As a result, porous cellulose particles weighing 1.2 g in terms of dry mass were obtained. The volume average particle size thereof measured in the same manner as in Example 1 was 126 μm.

### Example 35

Porous cellulose particles were obtained in the same manner as in Example 28, except that liquid paraffin as an organic dispersion medium used in the dispersion preparation step was replaced with rapeseed oil, and tetrahydrofuran as a coagulation solvent in the coagulation step was replaced with acetone.

As a result, porous cellulose particles weighing 1.1 g in terms of dry mass were obtained. The volume average particle size thereof measured in the same manner as in Example 1 was 142 μm.

### Example 36

Porous cellulose particles were obtained in the same manner as in Example 28, except that the number of times of performing the rinsing treatment was changed to 5 from 2 in the washing step.

As a result, porous cellulose particles weighing 1.3 g in terms of dry mass were obtained. The volume average particle size thereof measured in the same manner as in Example 1 was 74 μm.

### Example 37

Porous cellulose particles were obtained in the same manner as in Example 28, except that the number of times of performing the rinsing treatment was changed to 1 from 2 in the washing step.

As a result, porous cellulose particles weighing 1.1 g in terms of dry mass were obtained. The volume average particle size thereof measured in the same manner as in Example 1 was 82 μm.

### Example 38

Porous cellulose particles were obtained in the same manner as in Example 28, except that the number of times of performing the rinsing treatment was changed to 1 from 2 in the washing step, and the amount of distilled water used in a single session of the rinsing treatment was changed to 50 mL from 100 mL.

As a result, porous cellulose particles weighing 1.0 g in terms of dry mass were obtained. The volume average particle size thereof measured in the same manner as in Example 1 was 84 μm.

### Example 39

Porous cellulose particles were obtained in the same manner as in Example 28, except that the number of times of performing the rinsing treatment was changed to 1 from 2 in the washing step, and the amount of distilled water used in a single session of the rinsing treatment was changed to 10 mL from 100 mL.

As a result, porous cellulose particles weighing 1.3 g in terms of dry mass were obtained. The volume average particle size thereof measured in the same manner as in Example 1 was 85 μm.

### Example 40

Porous cellulose particles were obtained in the same manner as in Example 28, except that the washing step was not performed before the cross-linking step but performed after the cross-linking step.

As a result, porous cellulose particles weighing 1.2 g in terms of dry mass were obtained. The volume average particle size thereof measured in the same manner as in Example 1 was 89 μm.

### Example 41

Porous cellulose particles were obtained in the same manner as in Example 27, except that the washing step was not performed before the cross-linking step but performed after the cross-linking step.

As a result, porous cellulose particles weighing 1.1 g in terms of dry mass were obtained. The volume average particle size thereof measured in the same manner as in Example 1 was 184 μm.

[Evaluation of Porous Cellulose Particles]

For the obtained porous cellulose particles of Examples 27 to 41, the modulus of elasticity and the content of lithium ions and bromide ions in the dry porous particles having undergone the washing step preceding the cross-linking step were measured in the same manner as in Example 14.

Furthermore, the volume average particle size, the specific surface area, the average pore size, and the maximum pore size of the porous cellulose particles were measured in the same manner as in Example 1.

The evaluation results are shown in the following Tables 7 to 9.

TABLE 7

| | Example 27 | Example 28 | Example 29 | Example 30 | Example 31 |
|---|---|---|---|---|---|
| Cellulose | Crystalline | Crystalline | Crystalline | Crystalline | Crystalline |
| (degree of | cellulose | cellulose | cellulose | cellulose | cellulose |
| polymerization) | (220) | (220) | (220) | (220) | (220) |
| Cellulose | 2.5 g | 2.5 g | 2.5 g | 2.5 g | 1.5 g |
| (used amount) | | | | | |
| Solution for | 60% by mass | 60% by mass | 60% by mass | 60% by mass | 60% by mass |
| dissolving cellulose | aqueous lithium | aqueous lithium | aqueous lithium | aqueous lithium | aqueous lithium |
| | bromide solution | bromide solution | bromide solution | bromide solution | bromide solution |
| Dispersion solvent | Dichlorobenzene | Liquid paraffin | Liquid paraffin | Liquid paraffin | Liquid paraffin |
| Coagulation solvent | Methanol | Tetrahydrofuran | Tetrahydrofuran | Tetrahydrofuran | Tetrahydrofuran |
| Rinsing condition | 100 mL/twice | 100 mL/twice | 100 mL/twice | 100 mL/twice | 100 mL/twice |
| Amount of | | | | | |
| water/number of | | | | | |
| times | | | | | |
| Cross-linking step | Performed | Performed | Not performed | Performed (twice) | Performed |
| Order of steps | Rinsing → | Rinsing → | — | Rinsing → | Rinsing → |
| | Cross-linking | Cross-linking | | Cross-linking | Cross-linking |
| Particles before | 57 | 45 | — | 46 | 45 |
| cross-linking step | | | | | |
| Lithium ion | | | | | |
| concentration | | | | | |
| (mmol/kg) | | | | | |
| Particles before | 61 | 49 | — | 59 | 61 |
| cross-linking step | | | | | |
| Bromide ion | | | | | |
| concentration | | | | | |
| (mmol/kg) | | | | | |
| Modulus of | 12.2 | 12.4 | 8.2 | 14.7 | 11.2 |
| elasticity | | | | | |
| (MPa) | | | | | |
| Volume average | 186 | 78 | 86 | 80 | 46 |
| particle size | | | | | |
| (μm) | | | | | |
| Specific surface area | 168 | 218 | 192 | 214 | 194 |
| (m²/g) | | | | | |
| Average pore size | 620 | 430 | 670 | 480 | 520 |
| (nm) | | | | | |
| Maximum pore size | 1760 | 1320 | 1870 | 1720 | 1720 |
| (nm) | | | | | |

TABLE 8

| | Example 32 | Example 33 | Example 34 | Example 35 | Example 36 |
|---|---|---|---|---|---|
| Cellulose | Crystalline | Crystalline | Crystalline | Crystalline | Crystalline |
| (degree of | cellulose | cellulose | cellulose | cellulose | cellulose |
| polymerization) | (220) | (220) | (220) | (220) | (220) |
| Cellulose | 3.5 g | 2.5 g | 2.5 g | 2.5 g | 2.5 g |
| (used amount) | | | | | |
| Solution for | 60% by mass | 60% by mass | 60% by mass | 60% by mass | 60% by mass |
| dissolving cellulose | aqueous lithium | aqueous lithium | aqueous lithium | aqueous lithium | aqueous lithium |
| | bromide solution | bromide solution | bromide solution | bromide solution | bromide solution |
| Dispersion solvent | Liquid paraffin | Olive oil | Sesame oil | Rapeseed oil | Liquid paraffin |
| Coagulation solvent | Tetrahydrofuran | Acetone | Acetone | Acetone | Tetrahydrofuran |
| Rinsing condition | 100 mL/twice | 100 mL/twice | 100 mL/twice | 100 mL/twice | 100 mL/5 times |
| Amount of | | | | | |
| water/number of | | | | | |
| times | | | | | |
| Cross-linking step | Performed | Performed | Performed | Performed | Performed |
| Order of steps | Rinsing → | Rinsing → | Rinsing → | Rinsing → | Rinsing → |
| | Cross-linking | Cross-linking | Cross-linking | Cross-linking | Cross-linking |
| Particles before | 62 | 68 | 86 | 92 | 12 |
| cross-linking step | | | | | |
| Lithium ion | | | | | |
| concentration | | | | | |
| (mmol/kg) | | | | | |
| Particles before | 70 | 75 | 92 | 95 | 14 |
| cross-linking step | | | | | |
| Bromide ion | | | | | |
| concentration | | | | | |
| (mmol/kg) | | | | | |
| Modulus of | 14.3 | 11.6 | 10.9 | 12.1 | 15.1 |
| elasticity | | | | | |
| (MPa) | | | | | |
| Volume average | 94 | 95 | 126 | 142 | 74 |
| particle size | | | | | |
| (μm) | | | | | |
| Specific surface area | 220 | 216 | 154 | 162 | 220 |
| (m²/g) | | | | | |
| Average pore size | 250 | 420 | 520 | 430 | 460 |
| (nm) | | | | | |
| Maximum pore size | 820 | 1300 | 1420 | 1280 | 1580 |
| (nm) | | | | | |

TABLE 9

| | Example 37 | Example 38 | Example 39 | Example 40 | Example 41 |
|---|---|---|---|---|---|
| Cellulose | Crystalline | Crystalline | Crystalline | Crystalline | Crystalline |
| (degree of | cellulose | cellulose | cellulose | cellulose | cellulose |
| polymerization) | (220) | (220) | (220) | (220) | (220) |
| Cellulose | 2.5 g | 2.5 g | 2.5 g | 2.5 g | 2.5 g |
| (used amount) | | | | | |
| Solution for | 60% by mass | 60% by mass | 60% by mass | 60% by mass | 60% by mass |
| dissolving cellulose | aqueous lithium | aqueous lithium | aqueous lithium | aqueous lithium | aqueous lithium |
| | bromide solution | bromide solution | bromide solution | bromide solution | bromide solution |
| Dispersion solvent | Liquid paraffin | Liquid paraffin | Liquid paraffin | Liquid paraffin | Dichlorobenzene |
| Coagulation solvent | Tetrahydrofuran | Tetrahydrofuran | Tetrahydrofuran | Tetrahydrofuran | Methanol |
| Rinsing condition | 100 mL/once | 50 mL/once | 10 mL/once | 100 mL/twice | 100 mL/twice |
| Amount of | | | | | |
| water/number of | | | | | |
| times | | | | | |
| Cross-linking step | Performed | Performed | Performed | Performed | Performed |
| Order of steps | Rinsing → | Rinsing → | Rinsing → | Cross-linking → | Cross-linking → |
| | Cross-linking | Cross-linking | Cross-linking | Rinsing | Rinsing |
| Particles before | 162 | 350 | 730 | 820 | 1016 |
| cross-linking step | | | | | |
| Lithium ion | | | | | |
| concentration | | | | | |
| (mmol/kg) | | | | | |
| Particles before | 180 | 365 | 785 | 906 | 1064 |
| cross-linking step | | | | | |
| Bromide ion | | | | | |
| concentration | | | | | |
| (mmol/kg) | | | | | |
| Modulus of | 9.2 | 8.8 | 8.6 | 8.4 | 8.1 |
| elasticity | | | | | |
| (MPa) | | | | | |
| Volume average | 82 | 84 | 85 | 89 | 184 |
| particle size | | | | | |
| (μm) | | | | | |
| Specific surface area | 208 | 210 | 208 | 207 | 172 |
| (m²/g) | | | | | |
| Average pore size | 490 | 501 | 512 | 456 | 619 |
| (nm) | | | | | |
| Maximum pore size | 1600 | 1610 | 1570 | 1574 | 1795 |
| (nm) | | | | | |

From the results shown in Tables 7 to 9, it is understood that the porous cellulose particles of Examples 27 to 41 obtained by the manufacturing method of the present invention have a fine pore size, a large specific surface area, and a small maximum pore size. It is also understood that, because all of the obtained porous cellulose particles have a modulus of elasticity of equal to or greater than 8 MPa and have excellent mechanical strength, they can be suitably used for various purposes such as a carrier of chromatography and a filtering material.

Regarding the mechanical strength of the porous cellulose particles, through the comparison between Example 28 and Examples 36 to 39, it is confirmed that, by sufficiently performing the rinsing treatment in the washing step so as to reduce the content of lithium ions and bromide ions in the porous particles having not yet been subjected to the cross-linking step, the mechanical strength of the obtained porous cellulose particles can be further improved. Through the comparison between Example 28 and Example 30, it is understood that the mechanical strength is further improved by performing the cross-linking step twice.

Regarding the washing step, through the comparison between Examples 27 and 41 and between Examples 28 and 40, it is understood that, from the viewpoint of further improving the mechanical strength of the porous cellulose particles, to perform the washing step before the cross-linking step is more effective than to perform it after the cross-linking treatment.

The disclosure of JP2014-049274 filed on Mar. 12, 2014 is incorporated into the present specification by reference.

All of the documents, patent applications, and technical specifications described in the present specification are incorporated herein by reference, as if each of the documents, patent applications, and technical specifications are specifically and independently incorporated into the present specification by reference.

What is claimed is:

1. A method for manufacturing porous cellulose particles, comprising:
a cellulose solution preparation step of preparing a cellulose solution by dissolving cellulose in an aqueous lithium bromide solution;
a dispersion preparation step of preparing a cellulose solution dispersion by dispersing the cellulose solution in an organic dispersion medium; and
a coagulation step of coagulating cellulose in the cellulose solution dispersion by cooling the cellulose solution dispersion and adding a coagulation solvent thereto such that porous cellulose particles are obtained.

2. The method for manufacturing porous cellulose particles according to claim 1, further comprising:
a washing step of washing the porous cellulose particles obtained through the coagulation step.

3. The method for manufacturing porous cellulose particles according to claim 1, further comprising:
a cross-linking step of forming a cross-linked structure in the porous cellulose particles obtained through the coagulation step.

4. The method for manufacturing porous cellulose particles according to claim 2, further comprising:
a cross-linking step of forming a cross-linked structure in the porous cellulose particles obtained through the coagulation step.

5. The method for manufacturing porous cellulose particles according to claim 4,
wherein the washing step is performed at at least any one of a point in time before the cross-linking step or a point in time after the cross-linking step.

6. The method for manufacturing porous cellulose particles according to claim 5,
wherein the washing step is performed before the cross-linking step.

7. The method for manufacturing porous cellulose particles according to claim 6,
wherein the washing step is a step of making each of the content of lithium ions and the content of bromide ions in a dry mass of 1 kg of the porous cellulose particles become equal to or less than 800 mmol.

8. The method for manufacturing porous cellulose particles according to claim 3,
wherein the cross-linking step is a step of forming a cross-linked structure in the porous cellulose particles obtained through the coagulation step by using epichlorohydrin.

9. The method for manufacturing porous cellulose particles according to claim 1,
wherein the content of lithium bromide in the aqueous lithium bromide solution is equal to or greater than 50% by mass and equal to or less than 70% by mass.

10. The method for manufacturing porous cellulose particles according to claim 1,
wherein the content of cellulose in the cellulose solution is equal to or greater than 1% by mass and equal to or less than 15% by mass.

11. The method for manufacturing porous cellulose particles according to claim 1,
wherein a cooling rate at the time of cooling the cellulose solution dispersion is equal to or greater than 0.2° C./min and equal to or less than 50° C./min.

12. The method for manufacturing porous cellulose particles according to claim 1, further comprising:
a freeze-drying step of freeze-drying the porous cellulose particles so as to obtain freeze-dried porous cellulose particles.

13. Porous cellulose particles obtained by the method for manufacturing porous cellulose particles according to claim 1.

14. The porous cellulose particles according to claim 13,
wherein a modulus of elasticity of the porous cellulose particles calculated from a load at the time when the porous cellulose particles has a 5% strain measured by a microhardness tester is equal to or greater than 8 MPa.

15. The porous cellulose particles according to claim 13,
wherein an average pore size of the freeze-dried porous cellulose particles measured by mercury intrusion porosimetry is equal to or greater than 10 nm and equal to or less than 2,000 nm.

16. The porous cellulose particles according to claim 13,
wherein a specific surface area of the freeze-dried porous cellulose particles measured by mercury intrusion porosimetry is equal to or greater than 140 m²/g.

17. The porous cellulose particles according to claim 13 that has a volume average particle size of equal to or greater than 1 μm and equal to or less than 2,000 μm.

18. The porous cellulose particles according to claim 13,
wherein the content of lithium ions in 1 kg of dry particles obtained by drying the porous cellulose particles is equal to or greater than 0.0001 mmol and equal to or less than 100 mmol.

19. The porous cellulose particles according to claim 13,
wherein the content of bromide ions in 1 kg of dry particles obtained by drying the porous cellulose particles is equal to or greater than 0.0001 mmol and equal to or less than 100 mmol.
